(19) United States
(12) Patent Application Publication
(10) Pub. No.: US 2026/0203772 A1
(43) Pub. Date: Jul. 16, 2026

(54) METHODS AND APPARATUS FOR DETERMINING THE ORIGINATING STATUS OF A PRODUCT

(71) Applicants: BASF SE, Ludwigshafen am Rhein (DE); BASF COATINGS GMBH, Muenster (DE)

(72) Inventors: Victor KAUPE, Muenster (DE); Frank DUFENTESTER, Muenster (DE); Henning SCHWABE, Mannheim (DE); Dennis HAARDT, Mannheim (DE); Andreas WOLLNY, Ludwigshafen am Rhein (DE)

(21) Appl. No.: 19/134,525

(22) PCT Filed: Dec. 4, 2023
(86) PCT No.: PCT/EP23/84096

§ 371 Date: May 30, 2025

(30) Foreign Application Priority Data
Dec. 16, 2022 (EP) 22214149.1

(51) Int. Cl. G06Q 30/018

(52) U.S. Cl. CPC G06Q 30/018

(57) ABSTRACT

Disclosed herein are methods, apparatuses, systems and computer-elements for generating preference data associated with a product produced from at least one inbound material and for producing at least one product being associated with preference data, where the at least one product is produced by a production from at least one inbound material.

### TECHNICAL FIELD

The invention relates to methods, apparatuses, systems and computer-elements for generating preference data associated with a product produced from at least one inbound material and for producing at least one product being associated with preference data by a production from at least one inbound material.

### TECHNICAL BACKGROUND

The manufacturer or exporter of a product, such as a chemical product or a discrete product manufactured from different materials, may claim preferential treatment by establishing originating status in accordance with the rule of origin. Preferential treatment allows, for example, the product to be exported at preferential rates of duty (i.e. duty-free or duty-reduced) to a country of destination, provided that a preferential agreement exists between the country of origin and the country of destination. This may allow the manufacturer or exporter of an originating product to gain a competitive advantage over the manufacturer or exporter of a comparable non-originating product because the product is not subject to customs duties.

The data necessary to determine the preference data of the product is normally contained in declarations provided by the supplier(s) of the material(s) used to produce the product. The data contained in said declarations has to be integrated into existing systems used to determine the preference data of products. However, said data integration is cumbersome, laborious and prone to errors.

Hence, there is a need to simplify exchange and sharing of data on material(s) used to produce products, such as chemical products or discrete products, to simplify establishing the originating status of the product.

### SUMMARY

In an aspect disclosed is a computer-implemented method for generating preference data associated with a product, in particular a chemical product, wherein the product is produced by a production from at least one inbound material, the method including:
(a) receiving a request to generate the preference data, said request including product data associated with the product,
(b) retrieving—based on the received product data—preference data associated with the inbound material(s) from inbound material data associated with said inbound material(s), wherein the inbound material data associated with each inbound material is accessed-based on a decentral identifier associated with the respective inbound material data, and optionally based on data related to the respective inbound material data-by a data consuming service under control of a data providing service being associated with a data owner, said data owner being associated with the respective inbound material data;
(c) retrieving at least one rule of origin for attributing a country of origin to the product produced from the at least one material;
(d) generating preference data associated with the product based on the retrieved rule(s) of origin, the retrieved preference data, and the received product data; and
(e) providing, via a communication interface, the generated preference data.

In another aspect disclosed is a computer-implemented method for generating preference data associated with a product, in particular a chemical product, wherein the product is produced by a production from at least one inbound material and/or at least one intermediate product produced by said production from at least one of the inbound materials, the method including:
(a) receiving a request to generate the preference data, said request including product data associated with the product;
(b) retrieving—based on the received product data—preference data associated with the inbound material(s) from inbound material data associated with said inbound material(s), wherein the inbound material data associated with each inbound material is accessed—based on a decentral identifier associated with the respective inbound material data, and optionally based on data related to the respective inbound material data—by a data consuming service under control of a data providing service being associated with a data owner, said data owner being associated with the respective inbound material data, and/or
(c) generating preference data associated with the intermediate product(s) by
   retrieving—based on the receive product data—intermediate product data,
   retrieving at least one rule of origin for attributing a country of origin to the intermediate product(s), and
   generating preference data associated with the intermediate product(s) based on the retrieved rule(s) of origin, the retrieved preference data, and the retrieved intermediate product data;
(d) retrieving at least one rule of origin for attributing a country of origin to the product produced from the at least one material;
(e) generating preference data associated with the product based on the retrieved rule(s) of origin, the retrieved preference data associated with the inbound material(s) and/or the generated preference data associated with the intermediate product(s), and the received product data; and
(f) providing, via a communication interface, the generated preference data.

In yet another aspect disclosed is an apparatus for generating preference data associated with a product, in particular a chemical product, produced from at least one material, the apparatus comprising:
one or more computing nodes; and one or more computer-readable media having thereon computer-executable instructions that are structured such that, when executed by the one or more computing nodes, cause the apparatus to perform the methods disclosed herein.

In yet another aspect disclosed is a computer element, in particular a computer program product or a computer readable medium, with instructions, which when executed by one or more processor(s) are configured to carry out the steps of any of the methods disclosed herein.

In yet another aspect disclosed is a computer element, in particular a computer program product or a computer readable medium, with instructions, which when executed by one or more processor(s) cause any of the apparatuses disclosed herein to perform any of the methods disclosed herein.

In yet another aspect disclosed is a method for producing a product, in particular a chemical product, associated with preference data, wherein the product is produced by a production from at least one inbound material, the method including:
(a) providing the inbound material(s) to the production and producing a product from the provided inbound material(s) using the production,
(b) receiving a request to generate the preference data, said request including product data associated with the product,
(c) retrieving—based on the received product data—preference data associated with the inbound material(s) from inbound material data associated with said inbound material(s), wherein the inbound material data associated with each inbound material is accessed—based on a decentral identifier associated with the respective inbound material data, and optionally based on data related to the respective inbound material data—by a data consuming service under control of a data providing service being associated with a data owner, said data owner being associated with the respective inbound material data,
(d) retrieving at least one rule of origin for attributing a country of origin to the produced product, and
(e) generating preference data based on the received product data, the retrieved preference data and the received rule(s) of origin, and associating said generated preference data with the produced product.

In yet another aspect disclosed is a method for producing a product, in particular a chemical product, associated with preference data, wherein the product is produced by a production from at least one inbound material and/or at least one intermediate product produced by the production from one or more inbound ingredient(s), the method including:
(a) providing the inbound material(s) to the production and producing the product in part from the provided inbound material(s) using the production and/or producing intermediate product(s) from the provided inbound material(s) using the production and producing the product at least in part from the produced intermediate product(s) using the production,
(b) receiving a request to generate the preference data, said request including product data associated with the product,
(c) retrieving—based on the received product data—preference data associated with the inbound material(s) from inbound material data associated with said inbound material(s), wherein the inbound material data associated with each inbound material is accessed—based on a decentral identifier associated with the respective inbound material data, and optionally based on data related to the respective inbound material data—by a data consuming service under control of a data providing service being associated with a data owner, said data owner being associated with the respective inbound material data, and/or
(d) generating preference data associated with the intermediate product(s) by
   retrieving—based on the received product data—intermediate product data,
   retrieving at least one rule of origin for attributing a country of origin to the intermediate product(s), and
   generating preference data associated with the intermediate product(s) based on the retrieved rule(s) of origin, the retrieved preference data, and the retrieved intermediate product data;
(e) retrieving at least one rule of origin for attributing a country of origin to the produced product, and
(f) generating preference data based on the received product data, and/or the generated preference data associated with the intermediate product(s), and the received rule(s) of origin, and associating said generated preference data with the produced product.

In yet another aspect disclosed is a system configured to produce a product, in particular a chemical product, associated with preference data from one or more inbound material(s) and to provide the produced product associated with the preference data, the production comprising:
(a) a production line configured to produce the product from the inbound material(s) and to provide the produced product, wherein the product is connected to or comprises a physical identifier,
(b) a collector configured to collect product data associated with the product,
(c) a request receiver configured to receive a request to generate the preference data, said request including product data associated with the product,
(d) a preference data provider configured to retrieve—based on the received product data—preference data associated with the inbound material(s) from inbound material data associated with said inbound material(s), wherein the inbound material data associated with each inbound material is accessed—based on a decentral identifier associated with the respective inbound material data, and optionally based on data related to the respective inbound material data—by a data consuming service under control of a data providing service being associated with a data owner, said data owner being associated with the respective inbound material data,
(e) a rule provider configured to retrieve at least one rule of origin for attributing a country of origin to the product produced from the at least one inbound material;
(f) a preference data generator configured to generate preference data associated with the produced product based on the received product data, the retrieved preference data and the retrieved rule(s) rule of origin, and
(g) an assignor configured to assign the physical identifier to the generated preference data.

In yet another aspect disclosed is a system configured to produce a product, in particular a chemical product, associated with preference data from one or more inbound material(s) and/or from one or more intermediate product(s) produced by the production and to provide the produced product associated with the preference data, the production comprising:
(a) a production line configured to produce the product from the inbound material(s) and/or the intermediate product(s) and to provide the produced product, wherein the chemical product is connected to or comprises a physical identifier,
(b) a collector configured to collect product data associated with the product,
(c) a request receiver configured to receive a request to generate the preference data, said request including product data associated with the product,
(d) a preference data provider configured to
   (1) retrieve—based on the received product data—preference data associated with the inbound material(s) from inbound material data associated with said inbound material(s), wherein the inbound material data associated with each inbound material is accessed—based on a decentral identifier associated with the respective inbound material data, and optionally based on data related to the respective inbound material data—by a data consuming service under control of a data providing service being associated with a data owner, said data owner being associated with the respective inbound material data, and to
   (2) generate preference data associated with the intermediate product(s) by
      retrieving—based on the received product data—intermediate product data,
      retrieving at least one rule of origin for attributing a country of origin to the intermediate product(s),
      generating preference data associated with the intermediate product(s) based on the retrieved rule(s) of origin, the retrieved preference data, and the retrieved intermediate product data;
(e) a rule provider configured to retrieve at least one rule of origin for attributing a country of origin to the product produced from the at least one inbound material;
(f) a preference data generator configured to generate preference data associated with the produced product based on the received product data, the preference data provided by the preference data provider and the retrieved rule(s) rule of origin, and
(g) an assignor configured to assign the physical identifier to the generated preference data.

Establishing the originating status or origin of a product produced from at least one material allows to claim preferential treatment for said product by the product producer or product exporter if said product is exported to a country of destination having a preferential agreement with the country of the product origin. Preferential treatment allows, for example, the product to be exported at preferential rates of duty (i.e. duty-free or duty-reduced) to said country of destination, which may allow the product producer or product exporter of an originating or preferential product to gain a competitive advantage over a product producer or product exporter of a comparable non-originating or non-preferential product. The methods, apparatuses, systems, and computer elements disclosed herein provide an efficient way for determining preference data associated with a product, such as the origin of the product produced from at least one material supplied by a upstream participant of a supply chain while reducing or avoiding the need to integrate material data contained in declarations of material suppliers into existing systems used to determine preferential data associated with the product. The generated preference data may be used to control production of further products more efficiently from the product associated with said preference data. For instance, the product supply to a production located in a specific country can be steered more efficiently based on the generated preference data such that the further product produced by said production fulfills certain requirements concerning the origin of said produced further product.

By at least partly using inbound material passport(s) containing one or more decentral identifier(s) and associated inbound material data and optionally ingredient passport(s) containing one or more decentral identifier(s) and associated ingredient data allows a simplified and customizable data sharing or exchange from an inbound material supplier to a product producer or from a chemical product producer to a discrete product producer within the supply chain. This way, a more reliable and efficient determination of the preferential data associated with the product can be achieved, while the data remains in the ownership of the supplier supplying the upstream participant. The inbound material passport(s) may be stored within dedicated storage locations associated with respective data owners, such as inbound material producers supplying the material to downstream participants producing the product from such material. Likewise, the ingredient passports may be stored within dedicated storage locations associated with respective data owners, such as ingredient producers supplying ingredients to downstream participants producing the inbound material from such ingredients. The storage locations may be accessed via a decentral network. Access to such storage locations may be controlled via decentral data providing network nodes associated with respective data owners of data stored in such storage locations. Storage of such passport(s) within dedicated storage locations associated with the respective data owners allows to control access to such passports by such data owners. This contrasts with storage of such passports within decentral ledgers, such as blockchains, where access to data stored within such ledgers cannot be fully controlled by the data owner since the data owner does not have control over the storage locations storing copies of the distributed leger and hence also the data stored therein. In addition, data stored in the decentral ledger may be accessible by members of the decentral ledger network, such as a blockchain network, in particular in public blockchain networks. By associating the data related to inbound materials with the one or more decentral identifier(s) and optionally one or more authentication mechanisms more reliable and secure data sharing and exchange can be provided. By further including one or more authorization mechanisms, the data sharing or exchange can be conducted in a more flexible manner with multiple data consuming services from different participants of the supply chain accessing the material data. By linking the decentral identifier to a digital representation of the inbound material data or ingredient data, wherein the digital representation includes a representation for accessing the inbound material data or the ingredient data, inbound material data or ingredient data can be accessed via the decentral identifier and the digital representation in a robust and reliable manner in a one producer-to-multiuser environment. The inbound material data or ingredient data associated with the respective passport(s) has a standardized data format, thus rendering data integration into existing systems superfluous. Hence, the preference data contained in said inbound material data or ingredient data can be used directly to determine the preference data associated with the product(s) or associated with the material(s), respectively, thus avoiding risks associated with incorrect or only partial data integration.

### Embodiments

In the following, terminology as used herein and/or the technical field of the present disclosure will be outlined by ways of embodiments and/or examples. Where examples are given, it is to be understood that the present disclosure is not limited to said examples.

In an embodiment, product may be all product(s) resulting from the use of at least one inbound material and/or at least one intermediate product within a production, i.e. said material/intermediate product is used by the production to produce the product(s) or is used by the production in at least one production step of a sequence of production steps necessary to produce the product(s). Thus, the product may not necessarily contain the material/intermediate product in its original form (e.g. its original chemical composition or its original physical appearance), for example if the product is produced by reacting material(s)/intermediate product(s) or if the product is produced by changing the appearance of the material/intermediate product.

In an embodiment, inbound material may be one or more physical entities, ingredients, parts, components, subassemblies and assemblies that are provided to the production and that are used by the production to produce the product. In an embodiment, intermediate product may be one or more physical entities, ingredients, parts, components, subassemblies and assemblies that are produced by the production from one or more inbound materials provided to the production. The intermediate product(s) may then be used by the production to produce one or more product(s). In one embodiment, the inbound material may be a discrete or indiscrete material, e.g., may be a continuous volume of solid or liquid material in case of an indiscrete material or comprise a plurality of pieces, e.g., parts or components, in case of discrete material. Discrete material may refer to finished products that are distinct items capable of being easily identifiable, for example by counting. Examples of discrete materials include automobiles, airplanes, shoes, etc. A discrete material may be broken down at the end of its lifecycle so that its components can be recycled.

In one embodiment, the inbound material may be a chemical raw material or a chemical material. A chemical raw material may comprise a material that is used as an educt or starting material in a production process. It may be a virgin material or a reused material, e.g., a material having already gone through a production and use cycle. A virgin material may comprise newly extracted raw material, in particular, material that has not undergone a previous production-and-use cycle, in particular, has not been processed and/or used. A reused material, according to the present disclosure, may be a material that has already undergone a production-and-use cycle. For example, a reused material may be a material that has undergone, after use of the material, a treatment to prepare it for reuse. This may entail a processing step, e.g., recycling and/or other treatment steps, e.g., cleaning or the like. A recycled material is an example of a reused material. It may be a material having undergone, after use of the material, one or more processing steps. The processing steps may be such steps that enable the material to be introduced into a production step as a raw material. A chemical material may be a chemically processed material, such as a raw material having undergone at least one chemical reaction, for example an intermediate material used in a further production step.

In one embodiment, the inbound material may be a component. A component may comprise a plurality of discrete pieces. For instance, a component may be produced by assembling a plurality of discrete objects.

In one embodiment, the inbound material may be a component assembly. A component assembly may comprise a plurality of components. For instance, a component assembly may be produced by assembling a plurality of components.

In an embodiment, the production may be a chemical production, a chemical production network or a discrete production. The chemical production network may include one or more one or more chemical and/or mechanical process(es). The chemical production network may produce one or more product(s) through chemical and/or mechanical processing. The chemical production network may include multiple types of production processes for producing one or more products(s) and/or intermediate product(s) from one or more inbound material(s). The chemical production network may produce one or more product(s) from inbound material(s) provided to the chemical production network. The chemical production network may produce one or more intermediate product(s) from inbound material(s) provided to the chemical production network. The chemical production network may include a complex production network producing multiple chemical products via multiple production process(es). The chemical production network may include connected, interconnected and/or non-connected production process(es). The chemical production network may include a composite or Verbund network. The chemical production network may include one or more production process(es) with multiple production steps. The production steps included in the chemical network may be defined by the physical system boundary of the chemical production network. The system boundary may be defined by location and/or control over production processes or steps. The system boundary may be defined by a site of the chemical production network. The system boundary may be defined by production process(es) or step(s) controlled by one entity or multiple entities jointly. The system boundary may be defined by the value chain with staggered production process(es) or step(s) to the product, which may be controlled by multiple entities jointly or separately. The inbound material(s) may enter the physical system boundary of the chemical production network. The entry point(s) of the chemical production network may be marked by the entry of inbound material(s) to the chemical production network or the system boundary of the chemical network. The product(s) may leave the physical system boundary of the chemical production network. The exit point(s) of the chemical production network may be marked by the exit of product(s) from the chemical production network or the system boundary of the chemical network.

In an embodiment, an identifier element may be associated with or connected to the inbound material or the packaging of the inbound material. The identifier element may be associated with or connected to the inbound material at least on production of the inbound material. Through the identifier element, the inbound material data associated with the inbound may be accessible through a decentral network. The inbound material data may be associated with the decentral identifier. The identifier element may uniquely relate to the inbound material. The identifier element may uniquely relate to a digital inbound material identifier. The digital material identifier may uniquely relate to the inbound material. This way inbound material data may be provided per inbound material or for individual inbound materials. The inbound material identifier may include one or more decentral identifier(s) uniquely related to the inbound material. The inbound material identifier may relate to one or more decentral identifier(s) signifying the inbound material data. The decentral identifier may be a digital identifier of or for the decentral network. The decentral identifier may be a digital identifier provided to the decentral network and participant nodes of the decentral network. The decentral identifier may hence signify physical entities of inbound materials in the decentral network and participant nodes may be able to interpret the relation of the decentral identifier to the physical entities of inbound materials of the material chain.

In an embodiment, the decentral identifier may comprise any unique identifier uniquely associated with a data owner, such as the inbound material supplier or an ingredient supplier, and inbound material data or ingredient data, respectively. The decentral identifier may include one or more Universally Unique Identifier(s) (UUID(s)) or Digital Identifier(s) (DID(s)). The decentral identifier may be issued by a central or decentral identity issuer. The decentral identifier may include authentication information. Via the decentral identifier and its unique association with the data owner and respective data (e.g. inbound material data or ingredient data) access to the respective data may be controlled by the data owner associated with said respective data. This contrasts with central authority schemes, where identifiers are provided by such central authority and access to data is controlled by such central authority. Decentral in this context refers to the usage of the identifier in implementations as controlled by the data owner. The decentral identifier may include one or more identifier(s) used in the decentral network and allowing for data exchange via the decentral network. Data exchange may include discovery of the decentral identifier for participant nodes of the decentral network, authentication of participant nodes of the decentral network and/or authorization of data transfers via a peer-to-peer communication between participant nodes of the decentral network. The decentral identifier may be a digital identifier. Hence, the decentral identifier may not correspond to physical identifier(s) physically attached to the inbound (such as the packaging of the inbound material).

The inbound material(s) and the product may be part of a product ecosystem. The product ecosystem may include different chains including manufacturing, use and re-use. In these chains, one or more ecosystem participant(s) may contribute to the manufacture, use or re-use of the product. For example, the production chain may include raw material manufacturers and/or product manufactures. Further for example, the use chain may include product user, product maintainers and/or product distributors. Further for example, the re-use chain may include collectors, sorters, recyclers and/or re-furbishers. The participants of the product ecosystem may be connected via a decentral network. The decentral network may include one or more decentral network node(s) configured to perform data transactions. The decentral network may be a peer-to-peer decentral network. The decentral network may not be a decentral blockchain network. The decentral network node(s) may be associated with participants of the product ecosystem. The data transactions may be based on a transaction protocol including authentication and/or authorization mechanism(s). Based on the authentication and/or authorization mechanism(s) a peer-to-peer network between decentral network node(s) of the decentral network may be established. The one or more authentication mechanism(s) may be associated with or linked to the decentral identifiers. The one or more authentication mechanism(s) associated with the decentral identifiers may be provided to decentral network node(s). The one or more authentication mechanism(s) associated with the decentral identifiers may be accessible by decentral network node(s). The decentral configuration allows for more efficient use of computing resources and strengthens control by each data owner of the decentral network.

In an embodiment, the data providing service (also denoted as data providing node hereinafter) may comprise computer-executable instructions for providing and/or processing data, such as inbound material data, associated with the data owner for accessing and/or processing by a data consuming service (also denoted as data consuming node hereinafter). The data providing service and the data consuming service may be part of the decentral network. The data providing service may control the access to the inbound material data, in particular by data consuming service(s) via the decentral network. The data providing service may be connected to one or more dedicated data storage(s) storing the inbound material data/ingredient data and may be controlled or owned by the data owner of the inbound material data or ingredient data, respectively. This allows to retain full control over the respective data by the data owner but at the same time enabling sharing of the respective data under controlled conditions, for example by using appropriate authorization and authentication mechanisms or schemes, to facilitate generation of preference data associated with a product produced from inbound materials associated with the inbound material data and to improve production processes of further products from the product.

In an embodiment, the data consuming service may comprise computer-executable instructions for accessing and/or processing data, such as inbound material data, associated with the data owner, in particular the data owner associated with the inbound material data. The data consuming service may be controlled or owned by the product producer. The data consuming service may be controlled by the entity consuming the inbound material to produce the product. The data consuming service may be part of a decentral network. Via the data consuming service, the product producer may retrieve at least part of the inbound material data associated with the inbound material(s) necessary or used to produce the product, thus allowing to facilitate generation of the preference data without having to perform any data integration with the system(s) or apparatus(es) generating said preference data.

In an embodiment, the data owner may comprise any entity generating data, such as inbound material data or ingredient data. The generating node may be coupled to the entity owning physical products from or for which data, such as inbound material data or ingredient data, is generated. The data, such as inbound material data or ingredient data, may be generated by a third-party entity on behalf of the entity owning physical products from or for which data is generated. The generated data, such as inbound material data or ingredient data, may be stored on one or more dedicated data storage(s) owned or controlled or accessible by the data owner. The dedicated storage(s) may be accessible for the data owner. The dedicated data storage(s) may be accessed by a data consuming service using the decentral identifier and the data related to the material data. The data owner may be the material producer or the ingredient producer, respectively. Via the decentral identifier and its unique association with the data owner and inbound material data access to the inbound material data may be controlled by the data owner. Via the decentral identifier and its unique association with the data owner and ingredient data access to the ingredient data may be controlled by the data owner. The inbound material data may be accessible for the data owner. The ingredient data may be accessible for the data owner. The data owner may hence directly or indirectly own the material data or the ingredient data, respectively. The data owner may control access to the inbound material data via the data providing service of the data owner. The data owner may control access to the material data. The inbound material data may be associated with the data owner. The data owner may be the owner of the inbound material data or the material data owner. The inbound material data may be stored in a data base of or under control by the data owner. The data owner may control access to the ingredient data. The ingredient data may be associated with the data owner. The data owner may be the owner of the ingredient data or the ingredient data owner. The ingredient data may be stored in a data base of or under control by the data owner.

In an embodiment, rules of origin may determine where the product produced from at least one material or the material produced from at least one ingredient originates. Rules of origin may determine where the product has been produced from at least one material or where the material has been produced from at least one ingredient. Rules of origin may determine where the product has been manufactured from at least one material or where the material has been manufactured from at least one ingredient. The origin of the product may be seen as the economic nationality of said product traded in commerce. The origin of the material may be seen as the economic nationality of said material traded in commerce. Rules of origin enable to establish the origin and may be split into preferential rules of origin and non-preferential rules of origin. The rules of origin may be based on the customs tariff classification of the respective product or the respective material.

In an embodiment, non-preferential rules of origin may be used to determine the country of origin for the application of the most-favored nation treatment (MFN). The country of origin may be determined using non-preferential rules applicable if only one country is involved in the manufacturing of the product or material and non-preferential rules applicable if more than one country is involved in the manufacturing of the product or material.

In an embodiment, preferential rules of origin may be used to determine whether the product or material qualifies for the preferential tariff offered under a certain free-trade-agreement (FTA). These rules may include a set of criteria that the product or material needs to comply with in order to be considered originating in the territory of the trade agreement when exported to an FTA partner.

In an embodiment, the preferential rules of origin may be based on the customs tariff classification. The preferential rules of origin may be product or material specific. Each customs tariff classification eligible for preferential tariff under a trade agreement may be associated with a rule of origin. Preferential rules of origin may be defined at the commodity code/national tariff line level. Preferential rules of origin may be defined for a certain type of products within one customs tariff classification or commodity code. Preferential rules of origin may be negotiated separately for every FTA and may be attached to the main agreement in the form of a protocol or an annex on product specific preferential rules of origin. The preferential rules of origin for a specific FTA may therefore be retrieved from the respective protocol or annex. There are two main types of product specific preferential rules of origin, namely rules directed to “wholly obtained products” and rules directed to the “substantial transformation of materials used to produce the product”. Substantial transformation is a type of rules of origin that requires a product or material to undergo a certain process in order to be considered originating in a given country.

In an embodiment processor may refer to any circuitry, such as arbitrary logic or a quantum circuit, configured to perform basic operations of a computer or system, and/or, generally, to a device which is configured for performing calculations or logic operations. In particular, the processor or computer processor may be configured for processing basic instructions that drive the computer or system. It may be a semi-conductor based processor, a quantum processor, or any other type of processor configured for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified. In an embodiment a processor may also be seen as a subpart of a processor wherein this subpart is executing the method in form of a thread, a container and/or a virtual machine.

In an embodiment, a computing node may refer to any device or system that includes at least one physical and tangible processor, and a physical and tangible memory capable of having thereon computer-executable instructions that are executed by a processor. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In an embodiment memory or data storage medium may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

In an embodiment, computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. In an embodiment, computer readable program instructions may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive the computer readable program instructions from the network and may forward the computer readable program instructions for storage in a computer readable storage medium within the respective computing/processing device.

In an embodiment, communication interface may refer to a software and/or hardware interface for establishing communication such as transfer or exchange or signals or data. Software interfaces may be e. g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

The methods, apparatuses, systems, and computer elements of this disclosure may make use of distributed computing. Distributed computing may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In an embodiment, distributed computed may be realized in a federated network.

The methods, apparatuses, systems, and computer elements of this disclosure may make use of a decentral network. Decentral network may refer to any computing network that distributes information-processing workloads across multiple nodes instead of relying on a single central node. Each of these separate nodes serves as a mini central node that interacts independently with other nodes.

For material and product suppliers within a supply chain, calculating and proving the material or product origin and obtaining and managing the respective supplier declarations containing the necessary material or product data often involves a great deal of bureaucracy associated with the integration of the material data or product data contained said declarations into existing systems used to determine preferential data associated with the material or product. Said complex data integration processes harbor risks, such as incorrect or incomplete data transfer from the respective declaration(s) into the existing systems.

However, reliably and correctly establishing the originating status or origin of a product produced from at least one material is a prerequisite to claim the entitled preferential treatment for said product by the product producer or product exporter if said product is exported to a country of destination having a preferential agreement with the country of the product origin. Moreover, said origin status of a product allows to more efficiently control or manage the production of further products using said product by controlling the product supply to a production producing said further products based on the origin status of the product.

It is therefore highly desirable to provide methods, apparatuses, systems and computer-elements which avoid the necessity to integrate material data concerning the material origin provided by material supplier(s), for example in the form of supplier declarations, into existing systems used to determine preference data of a product produced from supplied materials based on the provided material data. It is moreover desirable to provide methods, apparatuses, systems and computer-elements which allow to control the production of further products based on the origin status of supplied products.

These and other objects, which become apparent upon reading the following description, are solved by the subject matters of the independent claims. The dependent claims refer to embodiments of the invention.

The preference data may be generated by the producer of the product, for example the producer associated with the production producing the products. For this purpose, the preference data of all materials used to produce the product needs to be known. In this respect, different scenarios might arise. For instance, inbound material(s) provided by supplier(s) to the production may be used within the production to produce the product. In this case, the preference data associated with all provided inbound material(s) may be retrieved from inbound material data associated with the respective inbound materials. For this purpose, the product producer may access, for instance using a data consuming service, the inbound material data—based on a decentral identifier associated with the respective inbound material data, and optionally based on data related to the respective inbound material data. The access of the inbound material data may be controlled by ay data providing service being associated with the data owner of said respective inbound material data.

In another instance, the inbound material(s) provided by supplier(s) and/or intermediate product(s) produced by the production from inbound material(s) may be used within the production to produce the product. In this case, the preference data associated with the produced intermediate product(s) may be generated prior to generation of the preference data associated with the product produced at least in part from said intermediate product(s). To generate preference data associated with the produced intermediate product(s), the product producer may retrieve preference data associated with respective inbound material(s) from the material data as described previously.

In yet another instance, a first intermediate product produced from one or more inbound material(s) may be used at least in part to produce another intermediate product. In this case, the preference data generated for the first intermediate product as described previously may be used to determine the preference data of the second intermediate product.

The preference data associated with a produced product may be used by the product consumer to control the production of further products using said product because production capacities can be controlled more efficiently based on said preference data. For instance, a product consumer can determine product input streams to a production site located in a specific country using the preference data associated with the product if the resulting further product needs to have a certain origin. This allows to control the supply of products more efficiently to downstream processing steps.

In an embodiment, preference data associated with the product includes at least the preferential origin status or the non-preferential origin status of the product for at least one country or at least one region. The preferential origin status is indicated for a specific country or region, such as the European Union. The non-preferential origin status is indicated for a specific country or region, such as the European Union. The preferential or non-preferential origin status of the product may be used to determine whether the product is entitled to preferential custom tariff treatment or not when exported to a specific country or region. The preferential or non-preferential status of the product may be used to control product supply to a production producing further products from the supplied product. For instance, the preferential or non-preferential status of the product may be used to determine a suitable production such that the resulting further product has a pre-defined origin, e.g. preferential or non-preferential status.

In an embodiment, the preference data associated with the product further includes the product data, in particular the product data contained in the received request, and data associated with inbound material(s) used in the production of the product.

In an embodiment, the product data includes a product identifier, price data, product composition data and/or a customs tariff classification associated with the product. The product identifier may relate to a LOT number and/or an order number assigned to the product. The LOT number may be assigned to a certain physical entity, quantity or group of the product. The LOT number may be assigned to the inbound material on production of said materials. The LOT number may refer to an identification number assigned to a particular quantity or lot of product from a single manufacturer. LOT numbers can typically be found on the outside of the packaging of the product. The LOT number may enable tracing of the constituent parts or ingredients as well as labor and equipment records involved in the manufacturing of the product. The LOT number may be assigned to the product on production. The order number may be assigned to the transfer of a certain physical entity, quantity or group of products to a product consumer. The order number may be assigned to the product transfer. The order number may relate to the product producer identity and the product consumer entity. The product identifier may be used to retrieve data associated with material(s) used to produce the product.

Customs tariff classification (also referred to as HS codes) may refer to the Harmonised System (HS) Classification, also called the HS Nomenclature. Said classification is the World Customs Organization's Harmonized Commodity Description and Coding System. It is an international customs classification system which allocates a unique 6-digit HS code to each group of products. The system was initially adopted by the Customs Cooperation Council in 1983. HS codes enable the customs authorities to identify the product and apply the appropriate import duty as well as other taxes and trade measures. The HS codes play an important role in determining the origin of products. The MFN (most favored nation) tariffs as well as preferential tariffs under FTAs are based on the HS classification. Rules of origin under any trade agreement will differ for products classified under different HS codes. In addition, HS classification is also an important part of assessing whether the good qualifies under various types of rules of origin. HS codes are composed of 6 digits and broken down into: Chapters (first 2 digits), Headings (first 4 digits) and Subheadings (full 6 digits). The HS codes are further subdivided into 7- to 12-digit items depending on the country (also referred to as commodity codes and national tariff lines).

The product composition data may include the bill of materials (also called BOM) associated with the produced product. The bill of material may be a list of the inbound material(s) and/or the intermediate product(s) the quantities of each material needed to produce the respective product. The bill of material can therefore also be regarded as the formula, recipe, or ingredients list.

Data associated with the inbound material(s) used in production of the product may include a description of the respective inbound material(s), the customs tariff classification of the respective inbound material(s) and/or the value, e.g. price, of the respective inbound material(s). Data associated with the inbound material(s) may be included in the preferential data depending on the origin status of the product. For instance, product(s) not having a preferential origin status may be associated with preferential data including data associated with the inbound material(s). In another instance, product(s) having preferential origin status may be associated with preferential data not including said data associated with the inbound material(s). The description of the respective inbound material may include an inbound material name, an inbound material ID or a combination thereof.

In an embodiment, the product data further includes data related to one or more countries or regions the preferential data is to be generated for. For instance, the product data may include an indication for which country/countries or for which region(s) the product needs to satisfy respective rule(s) of origin governing preferential trade with said country/countries or region(s). This allows to generate preference data which—apart from the data on the origin of the product—also contains data on countries for which origin governing preferential trade are fulfilled. The latter data allows to determine for which countries preferential custom tariff rates will apply if said product is exported.

In an embodiment, the request is received by a computing node of a computing system implementing the methods to generate preference data disclosed herein. The request contains product data associated with the product the preference data is to be generated for. The product data contained in the request may include the product data previously mentioned. The product data contained in the request may be collected from one or more data sources using one or more product identifier(s) associated with the produced product.

Depending on whether the intermediate product(s) produced by the production were used in the production of the product, the computing node may be configured to retrieve preference data associated with the inbound material(s) and/or to generate preference data associated with produced intermediate product(s) as described later on.

The preference data associated with the inbound material(s) may be retrieved based on the product data contained in the received request. In an embodiment, retrieving the preference data associated with the inbound materials(s) based on the received product data may include retrieving product composition data based on the received product data. The product composition data may be used to determine inbound material identifiers associated with the used inbound material(s). The inbound material identifier(s) may be used to determine the decentral identifiers associated with the respective inbound materials and inbound material data. Using the decentral identifier, data related to the inbound material data may be determined, for example by accessing a database of a decentral network and retrieving said data related to the inbound material data using the determined decentral identifier.

In an embodiment, retrieving the preference data associated with the inbound materials(s) based on the received product data may include retrieving inbound material composition data based on the received product data. The inbound material composition data may be used to determine inbound material identifiers associated with the used inbound material(s). The inbound material identifier(s) may be used to determine the decentral identifiers associated with the respective inbound material and inbound material data. Using the decentral identifier, data related to the inbound material data may be determined, for example by accessing a database of a decentral network and retrieving said data related to the inbound material data using the determined decentral identifier.

The preference data may be retrieved from inbound material data associated with the inbound material(s). The material data associated with each inbound material may be accessed based on decentral identifier(s) and optionally based on data related to the inbound material data. The inbound material data may be accessed by a data consuming node via a decentral network based on the decentral identifier(s) and optionally the data related to the inbound material data. The inbound material data may be accessed from a data providing node associated with the data owner of the inbound material data. The data providing node may be associated with a dedicated storage storing such inbound material data. The data providing node may be configured to gather inbound material data stored in such storage based on received decentral identifier(s) and to provide gathered inbound material data to the data consuming service(s) requesting said inbound material data. The decentral identifier may be associated with the inbound material data. Since the inbound material data is linked to the respective inbound material, for instance using an inbound material identifier, the decentral identifier is also associated with the inbound material the inbound material data is linked to. The decentral identifier may be used, optionally in combination with the data related to the inbound material data, within a decentral network to access the inbound material data by a data consuming service associated with the product consumer under control of a data providing service associated with the data owner of the inbound material data. This allows transfer of or access to the inbound material data in a controlled and secure manner as previously described.

In an embodiment, the decentral identifier is associated with the data owner. In an embodiment, the decentral identifier is associated with the inbound material the inbound material data is associated with. Associating the decentral identifier with the data owner may allow to retrain control over the inbound material data associated with the decentral identifier by the data owner. In addition, associating the decentral identifier with the data owner may allow verification of the inbound material data via the data owner. For instance, information on the data owner may allow to verify the origin of the inbound material data.

In an embodiment, the decentral identifiers is or is assigned to a physical identifier connected to the inbound material. Hence, the decentral identifier is or is assigned to a physical identifier connected to each inbound material used to produce the product. The physical identifier (also referred to as physical identifier element hereinafter) may refer to any virtual or physical arrangement that associates the decentral identifier with the respective inbound material. The physical identifier may be any identifier for the respective inbound material, such as a batch number or a part number. The physical identifier element may comprise a passive or active element, e.g. QR-code, RFID-tag, but is not limited thereto. The physical identifier element may be a physical identifier physically connected to the respective inbound material. The identifier element may include markers embedded in inbound materials, a bar code, a QR-Code, an embossed code, a tag like a RFID tag or similar physical arrangement that allows to digitally identify the respective inbound material. The connection of the physical identifier with the inbound material may be provided by means of physical connection to the physical material or physical entity. For instance, the physical identifier may be connected with the physical entity of the inbound material, i.e. may be physically attached to the inbound material, for example to the packaging of the inbound material. The physical identifier may have one-to-one correspondence to a virtual identity or to a physical identity by means of a physical connection to the physical entity.

The decentral identifier may be determined based on the physical identifier connected to the respective inbound material. The physical identifier may be provided from a sensor reading a physical identifier element physically connected to the inbound material. The physical identifier may be used to determine the decentral identifier(s), for example by accessing a database containing physical identifiers interrelated with the corresponding decentral identifier. The physical identifier may be used to determine the decentral identifier(s), for example by querying the decentral network for decentral identifier(s) linked to said physical identifier by using query data including the physical identifier.

In an embodiment, the preference data is retrieved using the decentral identifier and/or inbound material identifier(s) associated with the inbound material(s). For instance, the preference data may be retrieved from the inbound material data using the decentral identifier(s) associated with the inbound material. In another instance, the preference data may be received using an inbound material identifier associated with the respective inbound material. The inbound material identifier may be used if the inbound material data is stored, for example after accessing the inbound material data using a data consuming service, in a data storage associated with the material data consumer (e.g. the product producer) and the stored data is interrelated with such an inbound material identifier.

In an embodiment, the access to the inbound material data is based on an owner identifier associated with the data owner, in particular the data owner of the respective inbound material data. The owner identifier may be a string identifier associated with a data owner name. The owner identifier may be provided by a physical identifier provider, such as a bar code, embossed code, QR code or a tag like a RFID tag. Such communication can also be completed via ad hoc WIFI, BLE beacon, and/or NFC. The communications may be performed via any available communication channels, including but not limited to, web servers, ad hoc WIFI, BLE beacon signal, NFC, a barcode or QR code scanning, etc. Through the owner identifier, the material data can be associated with the material data owner by including the owner identifier. The owner identifier may be used for data transaction, such as sharing or exchanging material data. The owner identifier may be provided to the data consuming service. Providing the decentral identifier and the owner identifier of the data owner to a data consuming service may simplify tracking of data transactions. Any transaction in the data ecosystem can e.g. be associated with the clear name of the data owner.

In an embodiment, the access to the inbound material data is based on decentral participant identifier(s) associated with data consuming service(s). The decentral participant identifier(s) may be defined by access rule(s) associated with the inbound material. This allows to filter data consuming services based on associated decentral participant identifiers and to control access to the inbound material data based on said decentral participant identifiers. The access rule(s) may be defined by the data owner of the inbound material data to ensure that only particular participants of the decentral network are able to access the inbound material data, hence avoiding access to said inbound material data by all members of the decentral network. Storage of inbound material data in a storage associated with the material owner in combination with the use of access rule(s) allows the material owner to fully control access to the inbound material data. This contrasts with decentral networks based on distributed ledger technology, since the data owner may not control access to data stored in the distributed ledger by other decentral network participants.

In an embodiment, the access to the inbound material data is based on an access element associated with the inbound material. The access element may be stored in a decentral registry associated with or under control of the data owner of the inbound material data. The decentral registry may be associated with a decentral data providing network node associated with the data owner. The data owner may control access to such decentral registry via the associated decentral data providing network node. This contrasts with decentral networks based on distributed ledger technology (DLT) where the ledger which may be regarded as decentral registry is replicated over a plurality of network nodes which are not or are only partially controlled by the data owner of the inbound material data. The access element may include the decentral identifier and access data. The access data may point to the inbound material data or parts thereof. In this context pointing means any network representation or address that is suitable for accessing the respective inbound material data. The access may include an access point to the respective inbound material data, a link to access respective data, an endpoint to access the respective data or a service endpoint to access the respective data.

In an embodiment, the preference data associated with the respective inbound material includes data on the preferential origin status or the non-preferential origin status of said inbound material for at least one country, and an inbound material price. For instance, the preference data may include invoice data indicating the inbound material price as well as the preferential or non-preferential status. Use of invoice data within the inbound material data allows to retrieve all necessary information for an inbound material from a single data source via a single request to access the respective inbound material data, such as from data providing service associated with the respective material data, thus avoiding data conversion issues and multiple requests for necessary inbound material data. The preference data may be part of a supplier declaration issued for the respective inbound material. The supplier declaration may be contained in the respective inbound material data.

Data on the preferential origin status of the inbound material may include an inbound material identifier, the country or countries of origin of the inbound material, and the preferential country or countries. The inbound material identifier may include a material name, a CAS number, an inbound material ID, a LOT number, a batch number, or a combination thereof. The preferential country or countries may correspond to a country or countries for which the inbound material satisfies the rule(s) of origin governing preferential trade with said country or countries.

Data on the non-preferential origin status of the inbound material may include an inbound material identifier, an identifier associated with non-originating ingredient(s) used to produce the inbound material, a customs tariff classification associated with said non-originating ingredient(s) and a value associated with said non-originating ingredient(s). The identifier associated with non-originating ingredient(s) used to produce the inbound material may include an ingredient name, an ingredient ID, a CAS number of the ingredient, a LOT number of the ingredient, a batch number of the ingredient, or a combination thereof. Non-originating ingredient(s) may be ingredient(s) whose country of origin is not the same country as the country in which that ingredient is used in the production of the product.

In an embodiment, the decentral identifier(s) and optionally the data related to the inbound material data are associated with one or more authentication mechanisms or schemes. The authentication mechanism or scheme may include a token, such as private and public key infrastructure, a certificate mechanism or a biometric mechanism, such as fingerprints, face recognition or voice recognition or the like. One common public key certificate is for instance the X.509 certificate. Through the authentication mechanism or scheme, data access by a data consuming service can be controlled in a secure manner and integrity of the data providing service can be ensured. This allows for more reliable, controlled and secure data exchange or sharing. The one or more authentication mechanisms or schemes associated with the decentral identifier may be provided to at least one decentral authentication data registry, preferably accessible by the data providing service and/or the data consuming service. The authentication data registry may be a central registry such as a central file system, a centrally managed distributed database, and/or a centrally managed peer-to-peer network. The central configuration allows for higher control and standardization via a central node. The authentication data registry may be a decentral registry such as a distributed ledger, a decentralized file system, a distributed database, and/or a peer-to-peer network. The decentral configuration allows for more efficient use of computing resources and strengthens control by the data owner.

In an embodiment, the decentral identifier(s) and optionally the data related to the inbound material data are associated with one or more authorization mechanisms or schemes. The authorization mechanisms or scheme may include authorization rule(s) including data transaction instructions or data transaction protocols, such as data usage policies, smart data contracts or more complex data processing instructions associated with data providing and/or data consuming services. Through the authorization mechanism or scheme, data access and data usage by a data consuming service can be controlled in a secure manner. The one or more authorization mechanisms or schemes associated with the decentral identifier may be provided to a node for accessing the inbound material data. Additionally, or alternatively, the one or more authorization mechanisms may be provided to at least one central or decentral authorization data registry, preferably accessible by the data providing service and/or the data consuming service. The one or more authorization mechanisms or schemes associated with the decentral identifier may be provided to a node processing the inbound material data and to at least one a central file system, a centrally managed distributed database, a centrally managed peer-to-peer network, a distributed ledger, a decentralized file system, a distributed database, and/or a peer-to-peer network, preferably accessible by the data providing service and/or the data consuming service.

In an embodiment, the data related to the inbound material data includes inbound material data or parts thereof.

In one embodiment, the data related to the inbound material data includes one or more digital representation(s) pointing to the inbound material data or parts thereof. In this context pointing means any network representation or address that is suitable for accessing the respective inbound material data. The data related to material data may include multiple digital representations pointing to distinct parts of the respective inbound material data. The data related to the material data may include multiple digital representations pointing to different parts of the respective inbound material data. Such different parts may overlap in some data points. The digital representation may include an access point to the respective inbound material data, a link to access respective data, an endpoint to access the respective data or a service endpoint to access the respective data. This way the respective inbound material data can be maintained and controlled by the data owner associated with said inbound material data. Access can be provided via the representation of an access point simplifying data verification, integrity checks or quality checks and access control, since not multiple distributed data points need to be checked and access controlled.

If the digital representation includes a representation for accessing the respective inbound material data or a part thereof, such as a locator to the respective data or parts thereof, the respective data may be stored on a dedicated storage, for example a dedicated storage owned or controlled by the data owner associated with the inbound material data and may be accessed via a data consuming service using said locator. Use of a locator allows the data owner to retain the full control over the respective inbound material data because appropriate authorization and authentication is required to access the said data. This allows to openly share the decentral identifier and the data related to the inbound material data, for example on public web platforms, without having to disclose the respective inbound material data associated with said decentral identifier. Thus, transparency about existing endpoint(s) associated with said decentral identifier can be provided while at the same time ensuring the required level of confidentiality of the inbound material data associated with said decentral identifier.

The digital representation may be stored in a decentral registry associated with or under control of the data owner of the inbound material data. The decentral registry may be associated with a decentral data providing network node associated with the data owner. The data owner may control access to such decentral registry via the associated decentral data providing network node.

In an embodiment, the inbound material data further includes data related to a property of the inbound material and/or data related to the use of the inbound material. Such property may be a static or a dynamic property. A static property may be a property constant over time e.g. melting point, boiling point, density, hardness, flammability or the like. A dynamic property may be a property that changes over time e.g. shelf life, pH value, color, reactivity. Property of the inbound material may include performance properties, chemical properties, such as flammability, toxicity, acidity, reactivity, heat of combustion and/or physical properties such as density, color, hardness, melting and boiling points, electrical conductivity or the like. Data related to the use of the inbound material may include data related to further processing of the inbound material and, for example by using the inbound material as reactant in further chemical reaction(s) and/or data related to the use of the inbound material, for example data related to the use of the inbound material in a treatment process and/or within a manufacturing process.

In an embodiment, the inbound material data further includes emission data, recyclate content, bio-based content and/or production data. Recyclate content data and/or bio-based content data may comprise any data related to the recyclate content or the bio-based content used for providing or producing a physical entity of the inbound material. Emission data may comprise any data related to the environmental footprint. The environmental footprint may refer to an entity of the inbound material and its associated environmental footprint. Emission data may include data relating to carbon footprint of the inbound material. Emission data may include data relating to greenhouse gas emissions e.g. released in production of the inbound material. Emission data may include data related to greenhouse gas emissions. Emission data may include data related to greenhouse gas emissions of an entities or companies own operations (production, power plants and waste incineration). Scope 2 comprise emissions from energy production which is sourced externally. Scope 3 comprise all other emissions along the value chain. Specifically, this includes the greenhouse gas emissions of inbound materials obtained from suppliers. Product Carbon Footprint (PCF) sum up greenhouse gas emissions and removals from the consecutive and interlinked process steps related to a particular product. Cradle-to-gate PCF sum up greenhouse gas emissions based on selected process steps: from the extraction of resources up to the factory gate where the product leaves the company. Such PCFs are called partial PCFs. In order to achieve such summation, each company providing any products must be able to provide the scope 1 and scope 2 contributions to the PCF for each of its products as accurately as possible, and obtain reliable and consistent data for the PCFs of purchased energy (scope 2) and their inbound materials (scope 3). Production data may comprise any data related to the production of the inbound material. Production data may include monitoring and/or control data associated with the production of the inbound material. Production data may include measurement data related to a material quality of the inbound material.

In an embodiment, the inbound material data relates to or includes different classes of inbound material data. For instance, the data related to the inbound material data may include multiple digital representations pointing to different classes of the inbound material data. The different classes may include inbound material preference data, physical data associated with the inbound material, inbound material declaration data, inbound material safety data, certificate of analysis data associated with the physical entity of the inbound material, inbound material emission data, recyclate content data associated with the physical entity of the inbound material, bio-based content data associated with the physical entity of the inbound material, inbound material production data, and combinations thereof. For instance, at least one class may include inbound material declaration data, inbound material safety data and certificate of analysis data. The aforementioned data may be associated with more than the inbound material, such as with those ingredients/components used to produce the inbound material. In another instance, at least one class may include emission data, recyclate content data, bio-based content data and/or production data associated with the physical entity of the inbound material. The aforementioned data may be associated with more than the inbound material, such as with those ingredients/components used to produce the inbound material.

At least one class of the inbound material data may include inbound material data associated with at least one authorization mechanism or scheme. For instance, emission data, recyclate content data, bio-based content data, production data, preference data or combinations thereof may be access restricted. Such access restriction may be provided by an authorization mechanism or scheme. For instance, the authorization mechanism or scheme may include a rule that specifies which data consuming services get access under which conditions.

At least one class of inbound material data may include inbound material data not being associated with at least one authorization mechanism or scheme. For instance, inbound material declaration data, inbound material safety data, and/or certificate of analysis data associated with the physical entity of the inbound material may not be access restricted. Such access may be provided or ensured by an authorization mechanism or scheme. For instance, the authorization mechanism or scheme may include a rule that specifies that certain regulatory data for the material is accessible.

In an embodiment, the intermediate product data may include an intermediate product identifier, price data, intermediate product composition data and/or a customs tariff classification associated with the intermediate product. The intermediate product composition data may be used to determine inbound material identifiers associated with the used inbound materials(s). The inbound material identifier(s) may be used retrieve preference data from the respective inbound material data as previously described.

In an embodiment, retrieving the at least one rule of origin includes retrieving said rule(s) of origin from a data storage medium. The data storage medium may be an internal data storage medium of the computing system implementing the method for generating preference data disclosed herein. The data storage medium may be a database being connected to the computing system via a communication interface. The data storage medium may be a cloud storage.

In an embodiment, the at least one rule of origin is retrieved based on the received product data. For instance, the rule(s) of origin may be retrieved based on country data contained in the product data. In another instance, the rule(s) of origin may be retrieved based on the customs tariff classification contained in the product data.

In an embodiment, the at least one rule of origin includes at least one rule related to wholly obtained products and/or at least one rule related to the substantial transformation of a material used to produce the product.

Wholly obtained products may be products obtained entirely in the territory of an FTA party without the addition of any non-originating materials. Examples may include live animals born and raised there, mineral products extracted from the ground, food products grown and harvested in the territory of the party. Wholly obtained products may include products produced or manufactured exclusively from wholly obtained materials. Such products or materials typically receive the same treatment as wholly obtained products and are thus considered to fulfil the wholly obtained rule of origin if all the materials are wholly obtained.

The at least one rule related to the substantial transformation of the inbound material may include a rule defining a change in the customs tariff classification, a rule defining a value-added calculation, a rule allowing the use of certain inbound materials during production of the product, a rule prohibiting the use of certain inbound materials during production of the product and/or a rule defining a specific processing of the materials used to produce the product. The rule defining a change in customs tariff classification may require that non-originating inbound materials have undergone a change in customs tariff classification to obtain originating status of the product produced at least in part from said materials. The rule defining a value-added calculation may require that a certain percentage of the total value of the produced product is added in the applicable FTA (free-trade-agreement) territory. The rule defining a specific processing may require that a specific processing is undertaken at a particular stage of the production process of the product.

In an embodiment, generating preference data includes
determining the origin based on the received rule(s) of origin, the retrieved preference data associated with inbound material(s) and/or generated preference data associated with intermediate product(s), and the received product data, and
determining the preference status based on the determined origin.

For instance, if preference data for the product is to be generated, the origin of the product is determined using the received rule(s) of origin for attributing a country of origin to the produced product(s) the received preference data associated with the inbound materials used to produce the product and/or the generated preference data associated with intermediate product(s) produced from one or more inbound ingredient(s).

In another instance, if preference data for intermediate product(s) produced from one or more inbound ingredient(s) is to be generated, the origin of the respective intermediate product is determined using the received rule(s) of origin for attributing a country of origin to the produced intermediate product(s) and the received preference data associated with the inbound ingredients used to produce the intermediate product.

In an embodiment, generating preference data associated with intermediate products may further include using generated preference data associated with intermediate product(s) used to produce the intermediate product(s). For instance, a first intermediate product may be used to produce a second intermediate product. In this case, the preference data generated for the first intermediate product may be used—optionally along with the retrieved preference data associated with inbound material(s) used to produce said second intermediate product—to generate the preference data associated with the second intermediate product.

In an embodiment of the method for producing at least one product associated with preference data, associating the generated preference data with the at least one product includes linking the generated preference data to an identifier associated with the produced product. For instance, a product identifier associated with the produced product may be linked with the generated preference data. This may allow to retrieve the preference data using the respective product identifier. The product identifier may include a decentral identifier. For instance, a product passport may be generated including the decentral identifier associated with product data and the product data including the generated preference data. The product passport may be associated with a digital access element for accessing the preference data associated with the product included in the product passport, for example via a data consuming service associated with the product consumer. The product passport may hence signify a digital asset associated with the physical product and may be provided digitally when the produced product is physically provided to a downstream participant of the product ecosystem. The product passport may be stored in a dedicated storage associated with the data owner of the product passport, such as the product producer. For instance, the produced product may be provided to a customer and the customer may determine the decentral identifier associated with the received product, for example as described above. The decentral identifier may be used to determine the data related to the product data including said preference data as described above. The decentral identifier and data related to the product data may be used by the customer to access the product passport including the preference data using a data consuming service from a data providing service associated with a dedicated storage storing said product passport. Access to the product passport may be controlled by the data owner of the product passport, such as the product producer.

### BRIEF DESCRIPTION OF THE SEVERAL VIEWS OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The same reference numbers in the drawings and this disclosure are intended to refer to the same or like elements, components, and/or parts. The description is presented with reference to the accompanying drawings in which:

FIGS. 1A to 1C illustrate example embodiments of a centralized computing environment (FIG. 1A), a decentralized computing environment (FIG. 1B) and a distributed computing environment (FIG. 1C),

FIG. 1D illustrates an example embodiment of a decentral network environment including decentral participant network nodes associated with participants of a product ecosystem involving various products,

FIG. 2 illustrates an example of a chemical production network producing one or more chemical product(s) from one or more input material(s) in connection with an operating system including a preference data generation system,

FIGS. 3A and 3B illustrate a part of a chemical production producing coating materials from different raw materials,

FIG. 3C illustrates a part of a discrete production producing discrete products from different materials,

FIG. 3D illustrates part of a supply chain for producing a discrete product from chemical product(s) and further components,

FIG. 4A illustrates an example of an apparatus for generating preference data associated with a product produced from at least one inbound material,

FIG. 4B illustrates an example of an apparatus for generating preference data associated with a product produced from at least one inbound material and/or at least one intermediate product,

FIG. 5 illustrates an example of a system for producing at least one product associated with preference data,

FIG. 6 illustrates an example of a method or apparatus for providing preferential data associated with inbound material(s) and product(s) across value chains via a decentral network,

FIG. 7 illustrates an example of a material passport or a product passport including DID owner data, DID document data and decentral identity infrastructure,

FIG. 8 illustrates an example of material passport or a product passport including ID-based data, passport data and decentral identity infrastructure,

FIGS. 9A and 9B illustrates examples of authentication protocols between a data consuming service and a data providing service,

FIGS. 10A to 10C illustrate different example configurations for material passport or a product passport anchored by digital identifiers,

FIG. 11 illustrates a flow chart of a method for generating preference data associated with a product produced from at least one inbound material in accordance with an example embodiment of the present disclosure,

FIG. 12 illustrates a flow chart of a method for producing at least one product being associated with preference data and being produced by a production from at least one inbound material in accordance with an example embodiment of the present disclosure,

FIG. 13 illustrates a flow chart of an aspect of block 1108 of FIG. 10 and block 1110 of

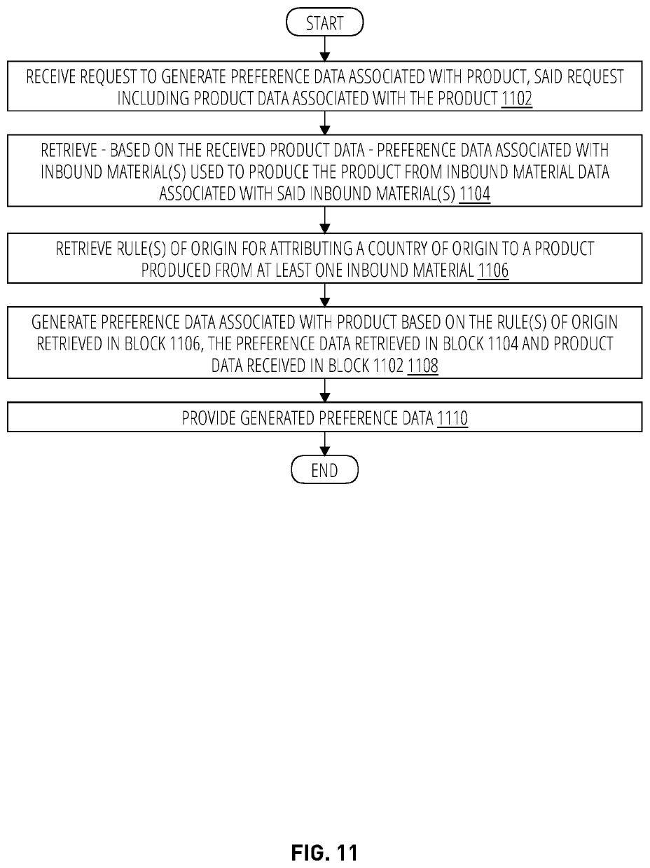

FIG. 11 in accordance with an example embodiment of the present disclosure,

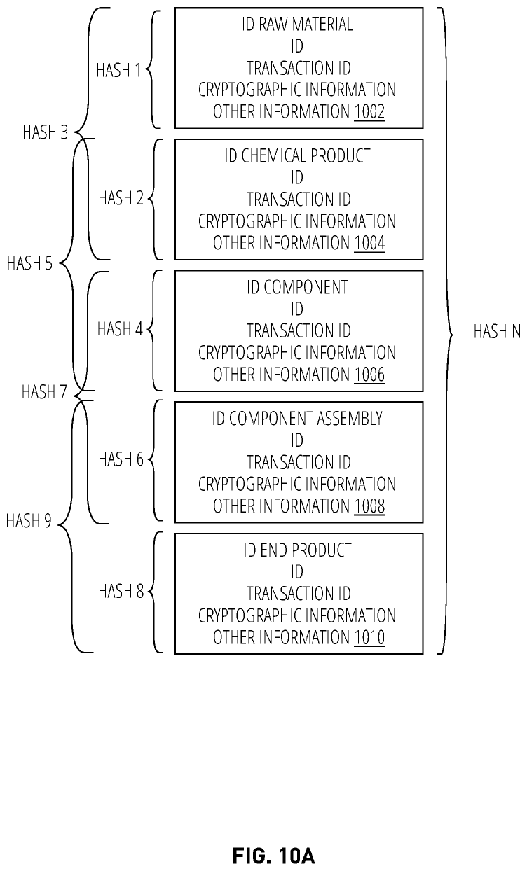

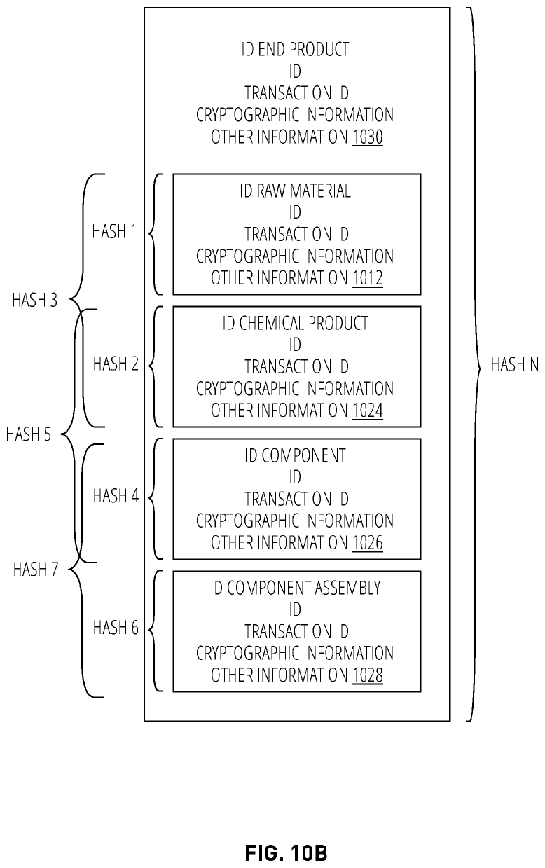

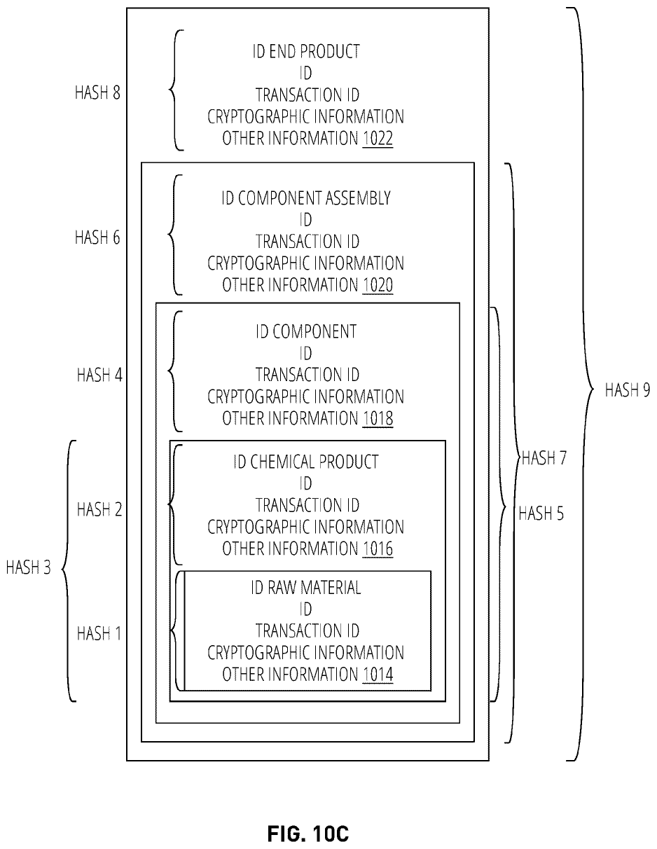

FIG. 14 illustrates a flow chart of an aspect of block 1006 of FIG. 10 and block 1106 of FIG. 11 in accordance with an example embodiment of the present disclosure,

FIG. 15 illustrates an example of a system for producing at least one product associated with preference data including an example method for generating preference data associated with a product produced from at least one inbound material,

FIG. 16 illustrates an example of a system for producing at least one product associated with preference data including an example method for generating preference data associated with a product produced from at least one inbound material and/or at least one intermediate product.

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks).

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

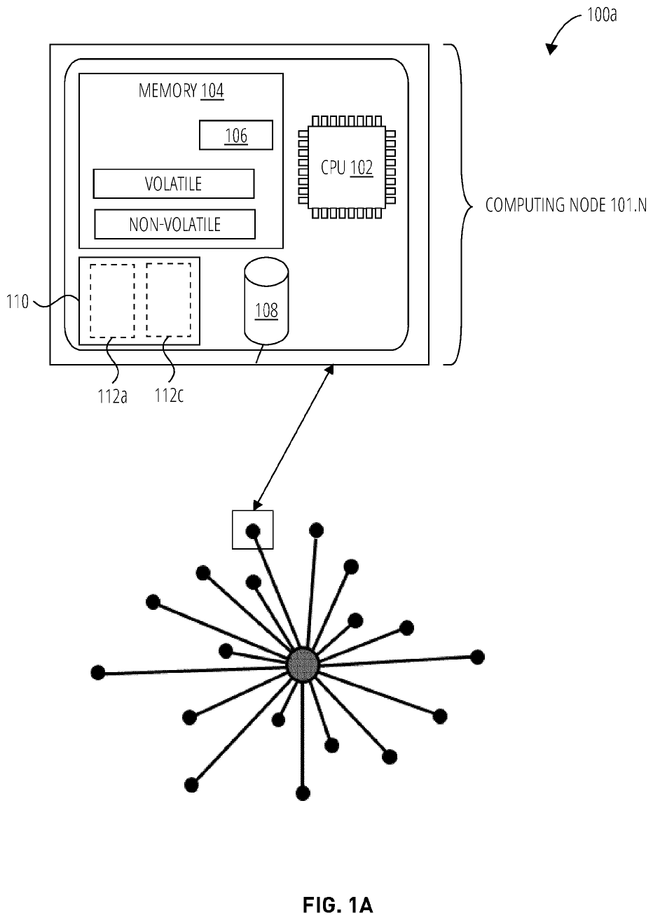

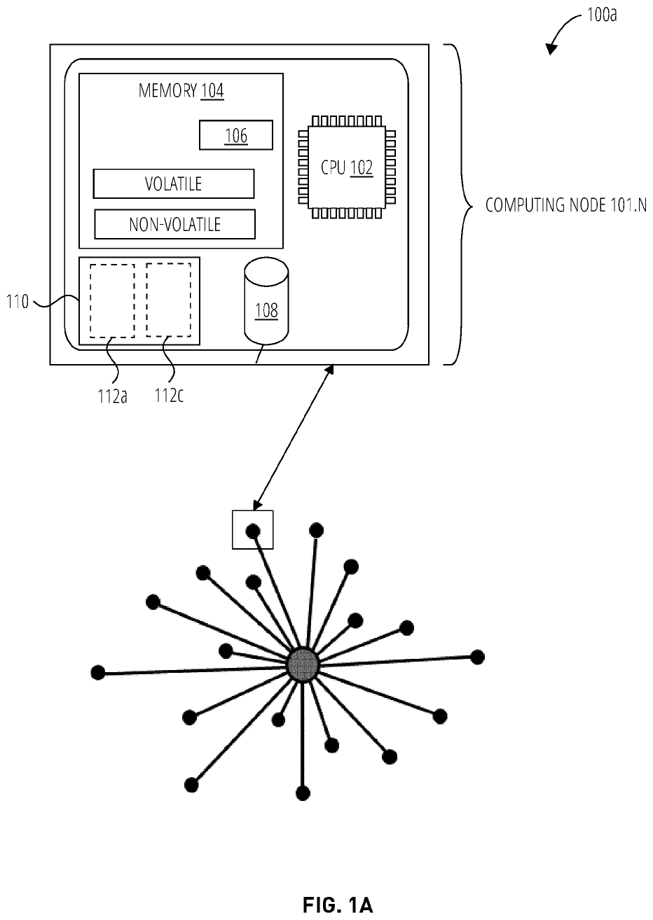

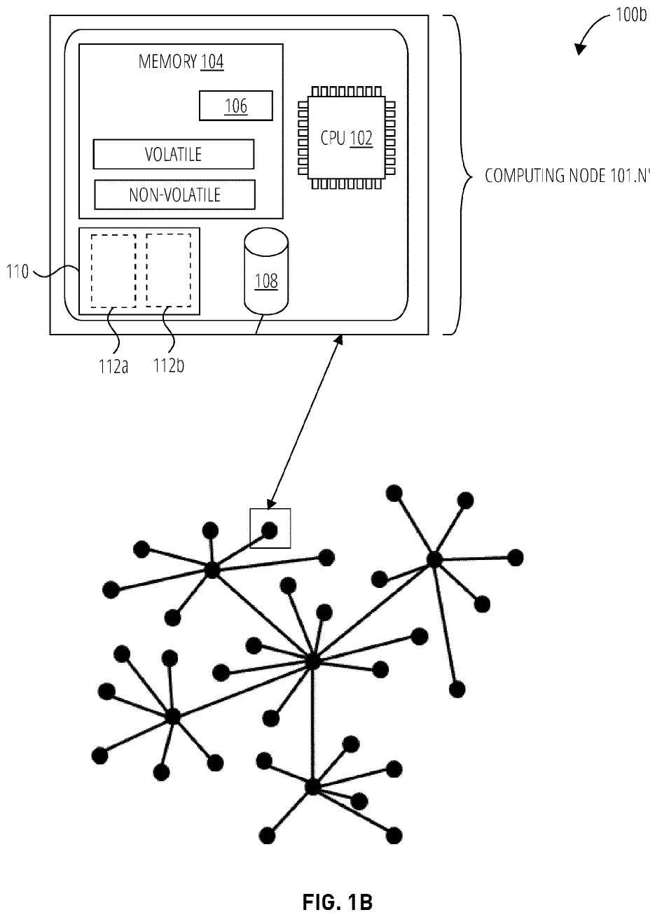

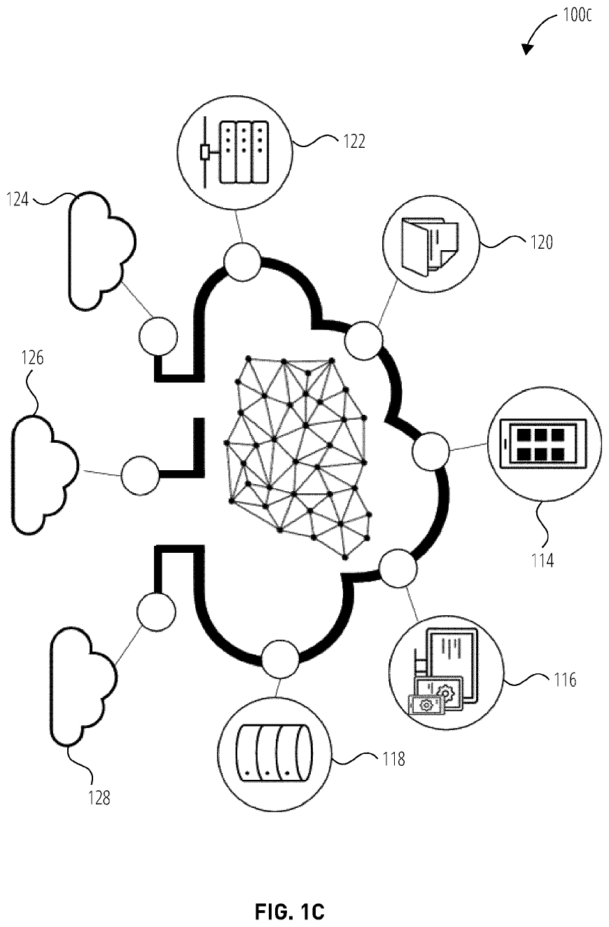

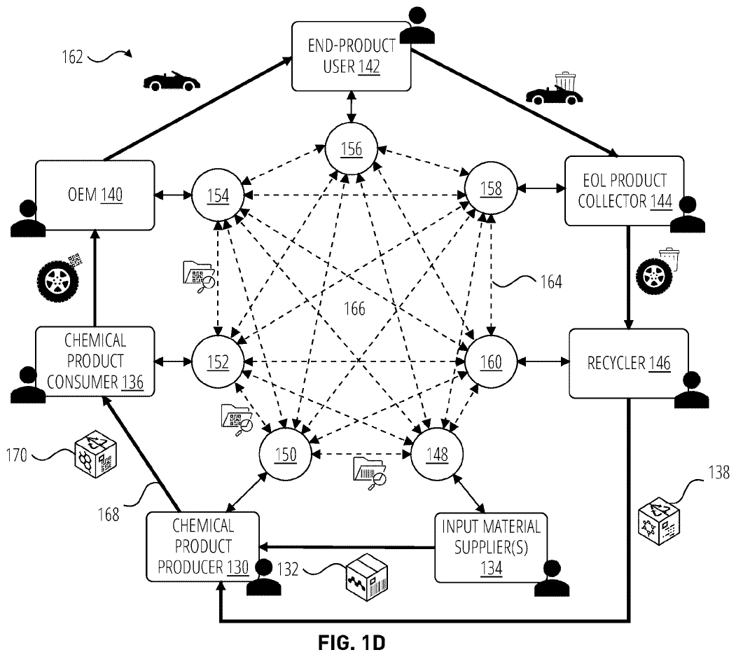

FIGS. 1A to 1C illustrate different computing environments, central, decentral and distributed. The methods, apparatuses, systems, and computer elements of this disclosure may be implemented in decentral or at least partially decentral computing environments. Providing, determining or processing of data may be realized by different computing nodes, which may be implemented in a centralized, a decentralized or a distributed computing environment.

FIGS. 1A, 1B illustrate example embodiments of a centralized and a decentralized computing environment with computing nodes. FIG. 1C illustrates an example embodiment of a distributed computing environment.

In this example of the centralized computing environment 100a, the peripheral computing nodes 101.1 to 101.N are connected to one central computing system (or server). In another example, the peripheral computing nodes 101.1 to 101.N may be attached to the central computing node via e.g. a terminal server (not shown). The majority of functions may be carried out by, or obtained from the central computing node (also called remote centralized location). One peripheral computing node 101.N has been expanded to provide an overview of the components present in the peripheral computing node. The central computing node may comprise the same components as described in relation to the peripheral computing node 101.N. Each computing node 101, 101.1 to 101.N may include at least one hardware processor 102 and memory 104.

The computing nodes 101, 101.1 . . . 101.N may include program code which is schematically represented as a plurality of structures 106. The multiple structures 106 may be referred to as an executable component, executable instructions, computer-executable instructions or instructions. Executable component or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.N, whether such an executable component exists in the heap of a computing node 101, 101.1 . . . 101.N, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.N (e.g., by a processor thread), the computing node 101, 101.1 . . . 101.N is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the words component, agent, manager, service, engine, module, virtual machine or the like are used synonymous with executable component.

The processor 102 of each computing node 101, 101.1 . . . 101.N may direct the operation of each computing node 101, 101.1 . . . 101.N in response to having executed computer-executable instructions that constitute an executable component. For example, such computer-executable instructions may be embodied on one or more computer-readable media that form a computer program product. The computer-executable instructions may be stored in the Memory 104 of each computing node 101, 101.1 . . . 101.N. Computer-executable instructions comprise, for example, instructions and data which, when executed at a processor 101, cause a general purpose computing node 101, 101.1 . . . 101.N, special purpose computing node 101, 101.1 . . . 101.n, or special purpose processing device to perform a certain function or group of functions. Alternatively, or in addition, the computer-executable instructions may configure the computing node 101, 101.1 . . . 101.N to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.N may contain communication channels 108 that allow each computing node 101.1 . . . 101.N to communicate with the central computing node 101, for example, a network enabling the transport of electronic data between computing nodes 101, 101.1 . . . 101.N and/or modules and/or other electronic devices. When information is transferred or provided over a network or another communications connection (either hardwired, wireless, or a combination of hardwired or wireless) to a computing node 101, 101.1 . . . 101.N, the computing node 101, 101.1 . . . 101.N properly views the connection as a transmission medium. Transmission media can include a network and/or data links which can be used to carry desired program code means in the form of computer-executable instructions or data structures and which can be accessed by a general-purpose or special-purpose computing nodes 101, 101.1 . . . 101.N. Combinations of the above may also be included within the scope of computer-readable media.

The computing node(s) 101, 101.1 to 101.N may further comprise a user interface system 110 for use in interfacing with a user. The user interface system 110 may include output mechanisms 112a as well as input mechanisms 112c. The principles described herein are not limited to the precise output mechanisms 112a or input mechanisms 112c as such will depend on the nature of the device. However, output mechanisms 112a might include, for instance, displays, speakers, displays, tactile output, holograms and so forth. Examples of input mechanisms 112c might include, for instance, microphones, touchscreens, holograms, cameras, keyboards, mouse or other pointer input, sensors of any type, and so forth.

FIG. 1B illustrates an example embodiment of a decentralized computing environment 100′with several computing nodes 101.1′to 101.N′ denoted as filled circles. In contrast to the centralized computing environment 100a illustrated in FIG. 1A, the computing nodes 101.1′to 101.N′ of the decentralized computing environment 100b are not connected to a central computing node and are thus not under control of a central computing node. Instead, resources, both hardware and software, may be allocated to each individual computing node 101.1′ . . . 101.N′ (local or remote computing system) and data may be distributed among various computing nodes 101.1′ . . . 101.N′ to perform the tasks. Thus, in a decentral system environment, program modules may be located in both local and remote memory storage devices. One computing node 101.N′ has been expanded to provide an overview of the components present in the computing node 101.N′. In this example, the computing node 101.N′ comprises the same components as described in relation to computing node 101.N of FIG. 1A.

FIG. 1C illustrates an example embodiment of a distributed computing environment 100c. In this example, the distributed cloud computing environment 100c may contain the following computing resources: mobile device(s) 114, applications 116, databases 118, data storage 120 and server(s) 122. The cloud computing environment 100c may be deployed as public cloud 124, private cloud 126 or hybrid cloud 128. A private cloud 126 may be owned by an organization and only the members of the organization with proper access can use the private cloud 126, rendering the data in the private cloud at least confidential. In contrast, data stored in a public cloud 124 may be open to anyone over the internet. The hybrid cloud 128 may be a combination of both private and public clouds 126, 124 and may allow to keep some of the data confidential while other data may be publicly available.

FIG. 1D illustrates an example embodiment of a decentral network environment. The decentral network environment may include a decentral participant network 162. The decentral participant network 162 may include one or more decentral network participants 130 to 146. The decentral network participants may be part of a product ecosystem including a variety of products, such as chemical products, components, part assemblies, end products and end-of-life products. The product ecosystem may include production chains to produce an end-product. The product ecosystem may include recycling chains to recycle at least a part of the end-of-life products originating from the use of the produced end-products. The product ecosystem may include an input material supplier(s) 134, a chemical product producer 130, a chemical product consumer 136, an OEM 140, an end-product user 142, an EOL product collector 144 and a recycler 146. The product ecosystem may allow to use materials resulting from recycling of end-of-life product to produce new end-products. The product ecosystem may be associated with the production of chemical products using one or more input materials and the use of the produced chemical products to produce further chemical products or discrete products.

The participant(s) of the decentral participant network 162 may be associated with the production of end-products and/or the recycling of end-of-life end products. The decentral network participant 130 to 146 may refer to a manufacturer of physical products, such as chemical product producer 130, chemical product consumer 136, OEM 140, end-product user 142, EOL product collector 144 and recycler 146. The decentral network participant may be associated with a decentral participant identifier. The decentral participant identifier may uniquely identify the decentral network participant within the decentral participant network 162.

The participant(s) of the decentral participant network 162 may be connected via material flow 168. The material flow 168 may correspond to the flow of product(s) from an upstream participant of the decentral participant network 162 to the respective downstream participant of the decentral participant network 162. The material flow 168 may refer to a continuous or a discontinuous flow of product(s). The flow of product(s) may include any means of transportation suitable to transport the product(s) from an upstream participant to the respective downstream participant. The means of transportation may include pipes, containers, barrels, packages. The material flow 168 may be associated with raw materials, chemical products, chemical intermediate products, parts, part assemblies, end-products, end-of-life products, recycled material, etc.

The data flow 164 between decentral network participant nodes may be directly or indirectly associated with the material flow 168 between the decentral network participants. For instance, data flow 164 may be directly associated with material flow 168 if input material data associated with a physical entity of an input material provided from input material supplier 134 to chemical product producer 130 is accessed by a decentral data consuming network node associated with said chemical product producer 130. For instance, data flow 164 may be indirectly associated with material flow 168 if data associated with a chemical product produced by chemical product producer 130 is accessed by a decentral data consuming network node associated with end-product user 142 or recycler 146.

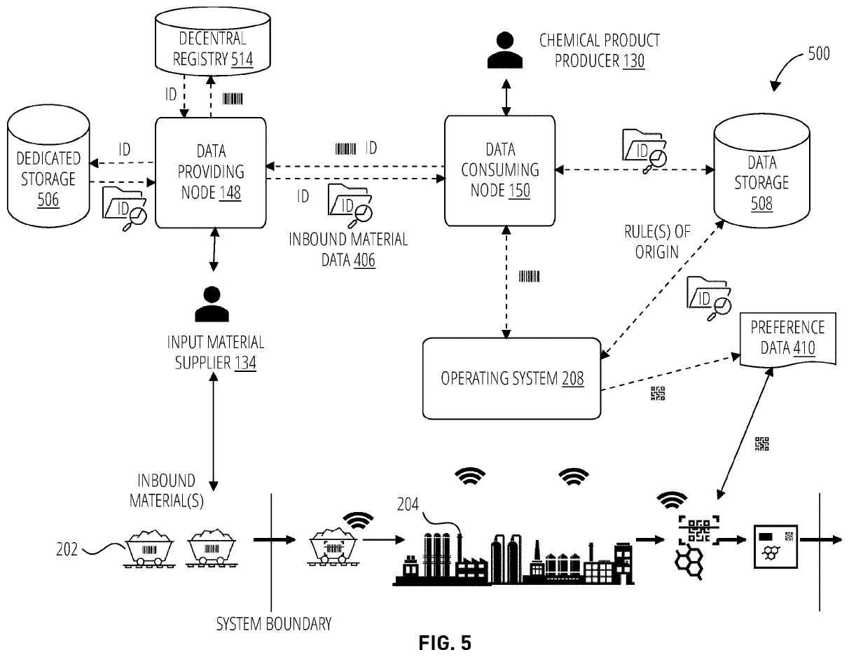

At least part of the participants of the decentral participant network 162 may be associated with decentral participant network nodes 148, 150, 152, 154, 156, 158, 160. The decentral participant nodes 148 to 160 may be under control of the respective decentral participant associated with the respective decentral participant node. The decentral participant nodes 148 to 160 may form decentral network 166. The decentral network 166 may be a peer-to-peer communication network. The decentral network 166 may not be based on distributed ledger technology (DLT), e.g. nodes of the decentral network 166 may not store a decentral ledger. The decentral network 166 may be configured to perform data transactions 164. The data transactions 164 may be based on a transaction protocol including authentication and/or authorization mechanism(s). Based on the authentication and/or authorization mechanism(s) a peer-to-peer communication between decentral network nodes 148 to 160 associated with decentral network participants 130 to 146 may be established. The one or more authentication mechanism(s) may be associated with or linked to a decentral identifier as described in the context of FIG. 5. The one or more authentication mechanism(s) associated with the decentral identifier may be accessible by a decentral data providing network node and/or a decentral data consuming network node as described in the context of FIG. 5. The decentral configuration allows for more efficient use of computing resources and strengthens control by the data owners of the decentral network.

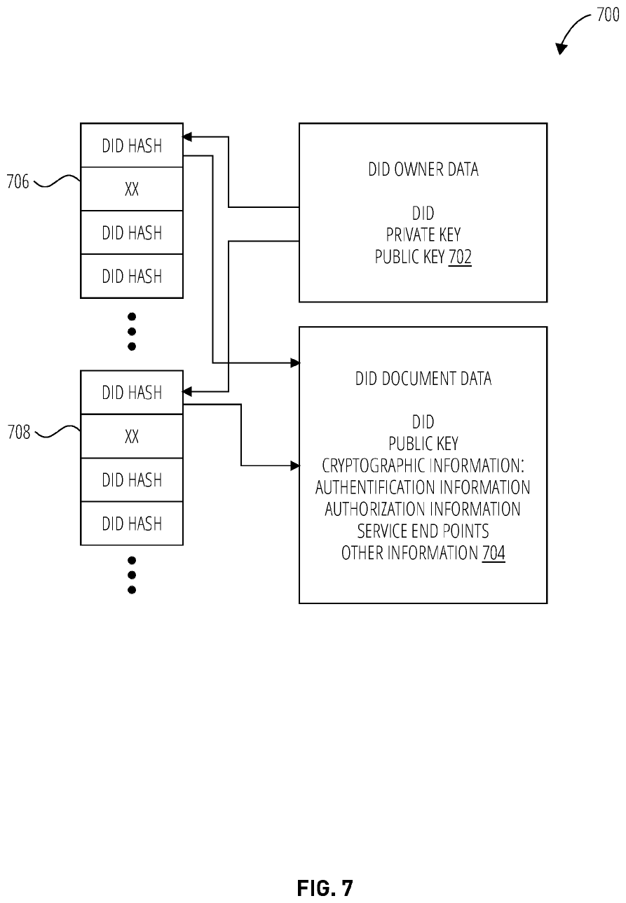

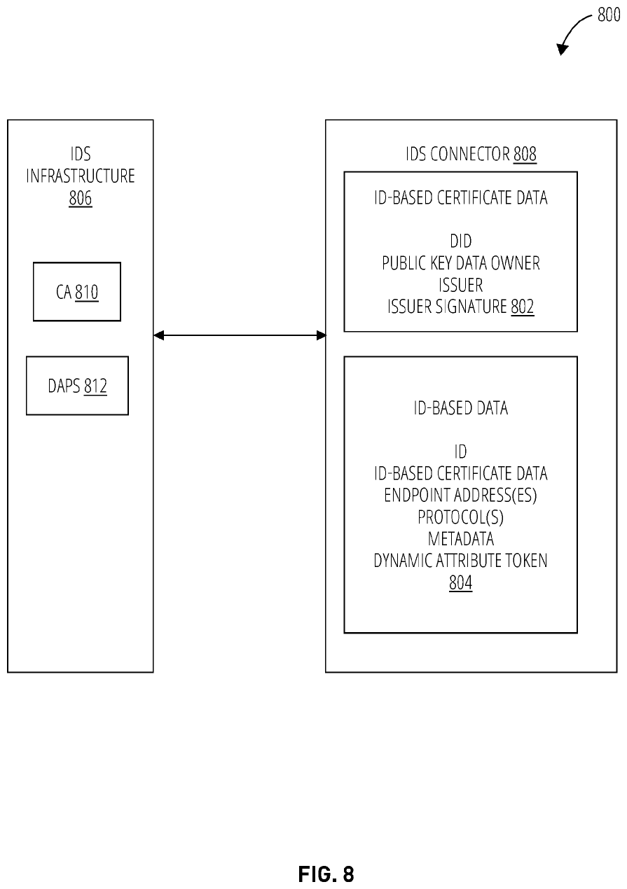

Data transactions between decentral network participant nodes may be based on a decentral identifier associated with the data to be accessed and/or decentral identifier(s) associated with material(s) used to produce the respective inbound material or output product. The decentral identifier may be uniquely associated with the physical entity of the inbound material and associated material data. The decentral identifier may be uniquely associated with the physical entity of the product and associated product data. The inbound material may be any raw material, chemical product, part or component, part assembly, end-of-life product or recycled material. The product may be any raw material, chemical product, part or component, part assembly, end-product, end-of-life product or recycled material. The decentral identifier may uniquely identify the respective inbound material or product within the decentral network. The decentral identifier may be associated with further decentral identifier(s), such as decentral identifier(s) of ingredients(s) used to produce the inbound material. This may allow to track the ingredients(s) used to produce the inbound material. The decentral identifier may be included in a digital access element associated with the input material or output product, for example as described in the context of FIG. 7 and FIG. 8.

The decentral participant nodes 148 to 160 may be decentral computing nodes. The decentral computing node may be any device or system that includes at least one physical and tangible processor, and a physical and tangible memory capable of having thereon computer-executable instructions that are executed by a processor. The memory may take any form and depends on the nature and form of the computing node.

At least part of the decentral participant nodes 148 to 160 may be decentral data providing network nodes. At least part of the participant nodes 148 to 160 may be decentral data consuming network nodes. A participant of the decentral participant network 162 may be associated with a decentral data providing network node and/or a decentral data consuming network node depending on whether data is provided to downstream participants and/or consumed from upstream participants. For instance, input material supplier(s) 134 may be associated with a decentral data providing network node configured to provide input material data associated with supplied input material(s) to a downstream participant (e.g. chemical product producer 130) for example as described in the context of FIG. 5. In addition to or alternatively, input material supplier(s) 134 may be associated with a decentral data consuming network node configured to receive input material data associated with supplied input material(s) from upstream participants (not shown) via a decentral data providing network node associated with said upstream participants.

The decentral network 166 may include further decentral network nodes. The further decentral network nodes may be decentral infrastructure service nodes (not shown in FIG. 1). The decentral infrastructure service nodes may not be associated with a participant of the product ecosystem. The decentral infrastructure service nodes may provide services for decentral participant nodes 148 to 160, such as verifying the identity of the decentral network participant nodes 148 to 160 prior to performing a data exchange. The decentral network participant nodes 148 to 160 may be associated with or include certificate(s), such as X.509 certificate(s). The certificate(s) may be associated with decentral infrastructure service node(s) including e.g. a certificate issuing service and/or a dynamic provisioning service providing dynamic attribute tokens (e.g. OAuth Access Tokens). This way the decentral network participant nodes 148 to 160 possess a unique identifier embedded in a X.509 certificate that identifies the respective decentral network participant node 148 to 160. The information required to verify the certificate may be provided via an authentication registry associated with the certificate issuing service and/or a dynamic provisioning service. For instance, in the IDSA Reference Architecture Model, Version 3.0 of April 2019, a decentral data providing network node associated with a data owner, a Certification Authority (CA), a Dynamic Attribute Provisioning Service (DAPS) and a decentral data consuming network node associated with a data consumer are used to verify the identity prior to performing a data exchange (not shown).

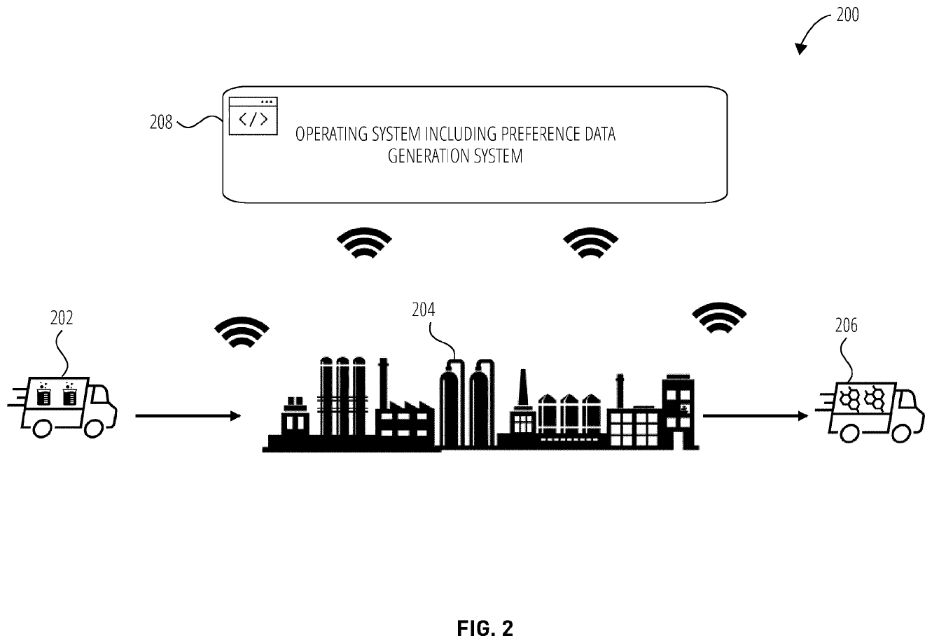

FIG. 2 illustrates an example of a production producing one or more product(s) from one or more material(s) and/or intermediate product(s) in connection with an operating system including a preference data generation system. The production 204 may be a chemical production producing chemical products from one or more chemical materials and/or intermediate chemical products.

For producing one or more product(s) 206, different inbound materials 202 may be provided as physical inputs from material providers or suppliers. The inbound materials 202 may be used directly to produce the products 206. The inbound materials 202 may be used to produce intermediate products and the intermediate products may be used to produce the products 206. The preference data of products 206 produced from provided inbound materials 202 may be determined according to the methods described herein using inbound material data associated with the provided inbound materials 202 (see also FIGS. 11 to 14B). The preference data of products 206 produced from provided inbound materials 202 and/or intermediate product(s) produced from provided inbound material(s) 202 by the production 204 may be determined according to the methods described herein using inbound material data associated with provided inbound materials 202 and generated preference data associated with the produced intermediate product(s) (see also FIGS. 11 to 14B).

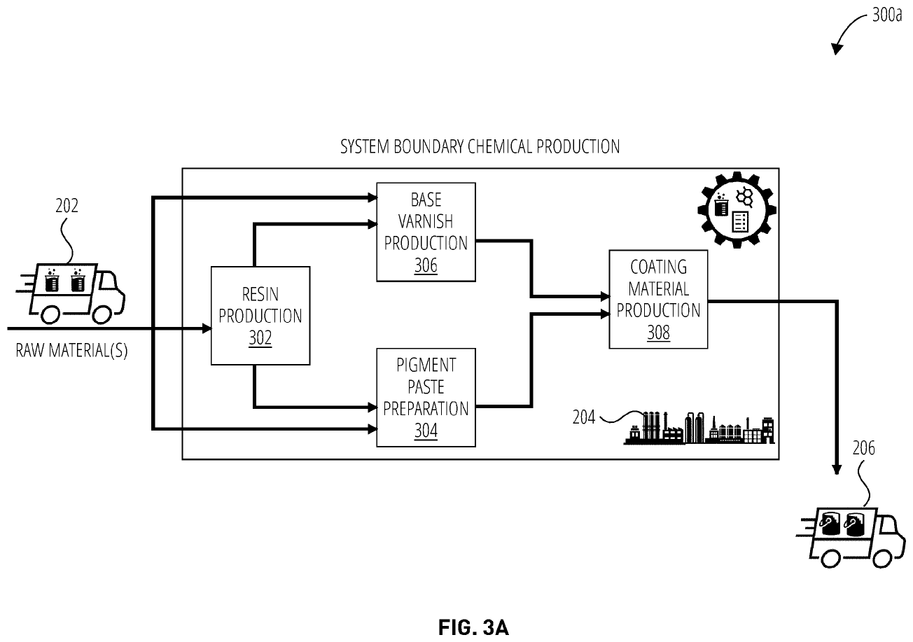

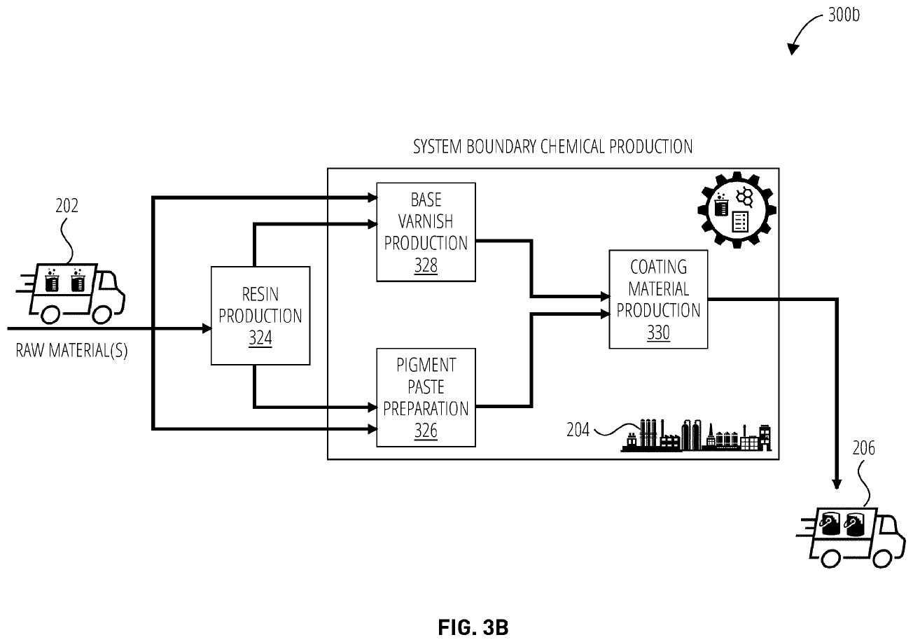

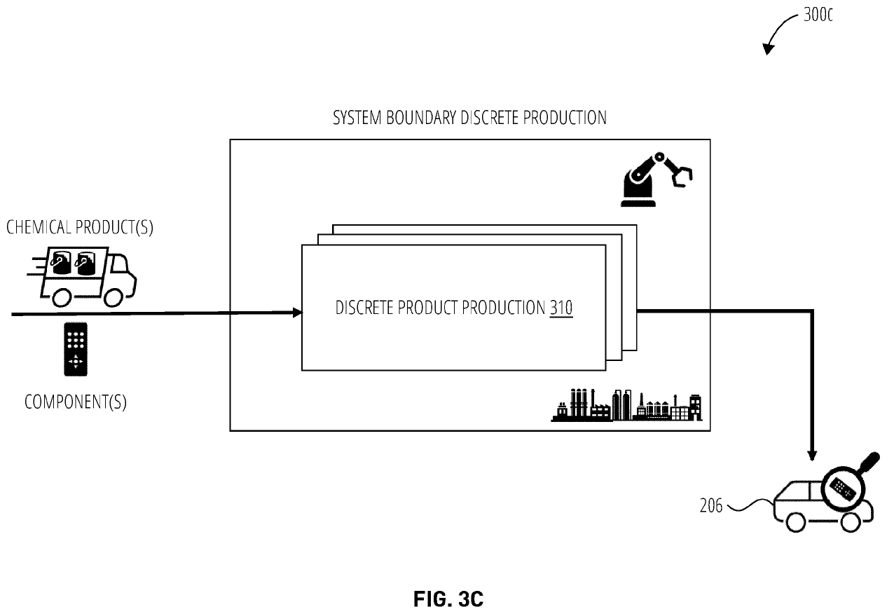

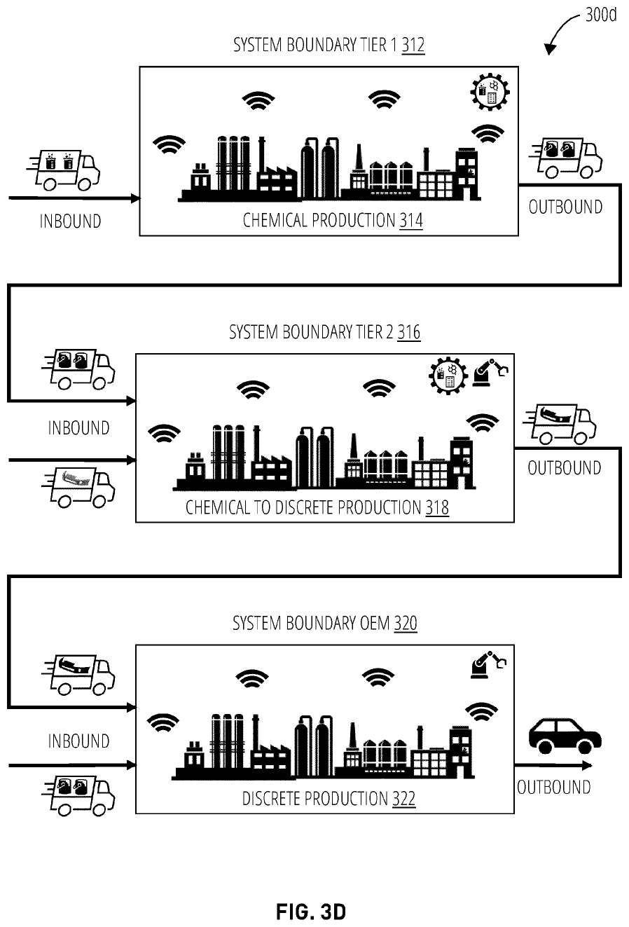

The production 204 may be a production network, such as a chemical production network, for example as described in FIGS. 3A and 3B. Production networks may include multiple types of production processes for producing different products from inbound materials. The production network may include a complex production network producing multiple products in multiple production chains. The production network may include connected, interconnected and/or non-connected production chains. The production network may produce from inbound materials multiple intermediate products and from the produced intermediate products chemical products. The production network may produce from inbound materials components or discrete products. Inbound material 202 may enter the production network at entry points. Products 206 may leave the production network at exit points.

The production network may include multiple interlinked processing steps. The production network may be an integrated chemical production with connected or interconnected production chains. The production network may include multiple different production chains that have at least one intermediate product in common. The production network may include multiple stages of the value chain. The chemical production network may include the production of different coating materials from one or more raw materials and/or intermediate products, for example as described in FIGS. 3A and 3B. The production network may include multiple production chains that produce from one or more inbound material(s) 202 chemical products 206 that exit the chemical production 204. The production network may include multiple production chains that produce from one or more inbound material(s) 202 chemical intermediate products that are used in further production chain(s) to produce the chemical product 206 leaving the chemical production 204. The production network may include multiple tiers of a value chain. The production network may include physically connected or interconnected production sites. The production sites may be at the same location or at different locations. In the latter case, the production sites may be connected or interconnected by means of dedicated transportation systems such as pipelines, supply chain vehicles, like trucks, supply chain ships or other cargo transportation means.

The production 204 may convert inbound materials 202 to one or more products 206 that exit the production 204. The conversion may be performed via intermediate products or components. The production 204 being a chemical production may convert the inbound material 202 by way of chemical conversion to one or more intermediate products and/or to one or more chemical products 206. The inbound materials 202 may be fed into the chemical production 204 at any entry point. The inbound materials 202 may be fed into the chemical production 204 at the start of the chemical production 204. Inbound materials 202 may include, for example, polymers, pigments, solvents and other components necessary to produce different coating materials.

The production 204 may include multiple production steps. The production steps may be defined by the system boundary of the production 204. The system boundary may be defined by location or control over production processes. The system boundary may be defined by the site of the production 204. The system boundary may be defined by production processes controlled by one entity or multiple entities jointly. The system boundary may be defined by value chain with staggered production processes to an end product, which may be controlled by multiple entities separately. The production 204 may include a waste collection and sorting step, a recycling step such as distillation, a separation step to separate outputs of one process step and further processing steps to convert such outputs to a product leaving the system boundary of the production 204.

The operating system 208 of the production 204 may monitor and/or control the production 204 based on operating parameters of the different processes. The operating system 208 may receive production demand data associated with the production planning for the production 204. The production demand data may be produced from target production capacities for one or more product(s) produced by the production 204. The production demand data may be produced from pre-defined production capacities or data-driven models that relate production capacities to market demand data. The production demand data may include target capacities for products produced by the production 204. The operating system 208 may further receive a bill of materials associated with intermediate product(s) and/or product(s) to be produced. The bill of materials may include data associated with the inbound materials used to produce the product (such as inbound material name, inbound material identifier, inbound material amount), process data associated with the production chain for producing the intermediate product and/or the product, and/or data associated with the intermediate product/and or product to be produced, such as an product specification data or data on the amount of intermediate product and/or product to be produced.

Based on the received production demand data and the bill of materials, material demand data may be determined. The material demand data may include data on the amount of inbound material required to produce the target capacities of intermediate chemical product and/or chemical product. The material demand data may include inbound material identifiers associated with inbound materials required to produce the intermediate product and/or product and data on amounts associated with the respective inbound materials. The material demand data may include one or more inbound material specifier(s) per inbound material identifier signifying the material specification. The material demand data may include data on the inbound material amount per inbound material identifier signifying the amount of inbound material to be supplied. The material demand data may specify the production chain(s) of the production 204. The material demand data may include a bill of materials for one or more production chain(s) of the production 204. The material demand data may include one or more recipe(s) specifying one or more inbound material(s) for production process(es) of the production 204. The determined material demand data may be provided for access by a supplier system associated with a supplier outside the physical system boundary of the chemical production. Material supply may be triggered by the supplier system accessing the material demand data.

One process step monitored and/or controlled by the operating system 208 may be the feed of inbound materials 202 or the release of products 206. Another process step monitored and/or controlled by the operating system 208 may the generation of preference data associated with intermediate products produced from inbound materials 202 by the production 204. Another process step monitored and/or controlled by the operating system 208 may the generation of preference data associated with products 206 produced by the production 204.

The operating system 208 may be configured to access data related the inbound materials 202, data related to the intermediate products, the processes and/or the products 206 produced by the production 204. The operating system 208 may be configured to receive a request to generate preference data for produced products 206, said request containing product data. The operating system 208 may be configured to retrieve preference data from inbound material data associated with provided inbound materials 202. The inbound material data may be accessed by a data consuming service associated with the operating system 208, for example as described in the context of FIG. 5. The data access may be controlled by a data providing service associated with the data owner, such as the data owner of the respective inbound material data. The operating system 208 may be configured to generate preference data associated with intermediate product(s) produced from one or more inbound materials based on the receive preference data associated with inbound material(s), rules of origin and intermediate product data retrieved based on the received product data. The operating system 208 may be configured to retrieve rule(s) of origin. The operating system 208 may be configured to generate preference data associated with produced products 206 based on the received preference data associated with the inbound material(s) and/or the generated preference data associated with intermediate product(s), rule(s) the retrieved rule(s) of origin and the received product data. The operating system 208 may be configured to retrieve rule(s) of origin. The operating system 208 may be configured to generate preference data associated with produced intermediate products based on the received preference data, rule(s) the retrieved rule(s) of origin and the received material data associated with said intermediate products.

FIGS. 3A and 3B illustrate a part of a chemical production 204 producing coating materials 206 from different inbound materials 202, such as different raw materials. The chemical production 204 may be a chemical production network as described in relation to FIG. 2.

The chemical production 204 may comprise a system boundary. In this example, the raw material streams form the entry point into the chemical production 204. The chemical products 206 produced from the chemical production 204 form the exit point out of the chemical production 204. The chemical production 204 may be a coating material production and the chemical products exiting the chemical production 204 may be coating materials. The chemical production 204 may include different production chains for different coating materials, such as pigmented coating materials and unpigmented coating materials. The production of pigmented coating materials may again be performed using different production chains, each production chain being assigned to the production of a specific type of pigmented coating material.

The chemical production 204 may comprise a resin production 302. The resin production 302 may comprise one or more resin production units, each unit producing a specific resin, and one or more material storages associated with each production unit. The resins exiting the resin production 302 may be regarded as intermediate products. Resins produced by the resin production 302 may include polymers, such as film-forming polymers. Examples of film-forming polymers include alkyd resins, polyester resins, polyimides, silicone resins, novolak resins, urea resins, melamine resins, amino resins, polyurethane resins, epoxy resins, polyolefin resins, polyvinyl resins, polyacrylic resins, polymethacrylic resins, or copolymers thereof.

The resin production 302 may be fed by a raw material stream (inbound material stream) containing the inbound materials 202 necessary to produce the respective resin. The raw material stream may include one or more monomers or pre-polymers necessary to produce the respective resin. Monomers may include low molecular weight compounds (e.g. less than 1000 g/mol) comprising at least one functional group capable of reacting with a further functional group. Pre-polymers may include polymeric materials (i.e. materials being obtained by reacting at least two monomeric materials). The raw material stream may further include solvents and further additives necessary to produce the respective resins, such as radical starters, surfactants, neutralizing agents, etc. The respective resin may be produced by an appropriate chemical polymerization reaction from the raw material stream. The respective resin may be produced batch-wise or in a continuous manner using appropriate resin production units, such as reactors.

The resin production 302 may be connected to pipes or lines which allow the supply of different raw materials stored in a material storage, such as a tank. The supplied amount of inbound material 202 may be determined using a sensor and the sensor data may be used by the operating system 208 described in relation to FIG. 2 to control the respective inbound material feed. The resin production 302 may also allow addition of inbound materials having a defined weight, for example weighted quantities of solids or liquids which are supplied as discretely packaged products, such as in bottles or bags.

The resin production 302 may comprise a polymerization step. The resin production may further include a neutralization step and/or a step removing organic solvents used in the polymerization step. The produced resin may be supplied to a material storage, such as a tank.

The resin production 302 may be controlled by the operating system 208 described in relation to FIG. 2 based on received material demand data or based on received bills of materials.

The chemical production 204 may further comprise a pigment paste preparation 304. The pigment paste preparation 304 may be fed by a stream containing the inbound materials and/or intermediate product(s) necessary to produce the respective pigment pastes. Intermediate product(s) may include resins(s) produced by the resin production 302. Inbound materials may include pigments, for example color and/or effect pigments, fillers, additives and solvents. The pigment paste preparation 304 may be connected via pipes with the resin production 302 to allow supply of produced resins as intermediate products. The pigment paste preparation 304 may be connected to material storage via lines or pipes and the amount of respective inbound material and/or intermediate product may be supplied using sensors to allow the operating system 208 to control the feed of raw materials based on sensor data. The pigment paste preparation 304 may also allow addition of raw materials having a defined weight, for example weighted quantities of solids or liquids which are supplied as discretely packaged products, such as in bottles or bags. The pigment paste preparation 304 may be controlled by the operating system 208 described in relation to FIG. 2 based on received material demand data or on received bills of materials.

The pigment paste preparation 304 may comprise mixing units (also denoted as dispersing units), milling units and material storage. The mixing units and milling units may be connected with pipes or lines to allow passage of the mixed material to the milling unit(s). The raw material stream may be supplied to one or more mixing units for mixing. Afterwards, the mixed material may be supplied to one or more milling units to prepare the respective pigment paste. The prepared pigment paste may be adjusted to standardized tinting strength and supplied to a material storage.

The chemical production 204 may further comprise a base varnish production 306. The base varnish production 306 may include one or more mixing units and a material storage. The base varnish production 306 may be fed by a material stream containing the materials necessary to produce the respective base varnish. Materials may include intermediate product(s), such as resins(s) produced by the resin production 302, and inbound materials, such as solvents and additives. Additives may include thickening agents, anti-settling agents, anti-sagging agents, light stabilizers, anti-foaming agents, adhesion promoters, etc. The base varnish production 306 may be connected via pipes with the resin production 302 to allow supply of produced resins. The base varnish production 306 may be connected to material storage via lines or pipes and the amount of inbound material(s) and/or intermediate product(s) may be supplied using sensors to allow the operating system 208 to control the feed inbound materials and/or intermediate product(s) based on sensor data. The base varnish production 306 may also allow addition of inbound materials and/or intermediate product(s) having a defined weight. The base varnish production 306 may be controlled by the operating system 208 described in relation to FIG. 2 based on received material demand data or on the received bills of materials.

The chemical production 204 may further comprise a coating material production 308. The coating material production 308 may include one or more mixing units, one or more filtration units and one or more material storages. The coating material production 308 may be fed by a material stream containing the materials necessary to produce the respective coating material. Materials may include intermediate product(s), such as pigment paste(s) produced by the pigment paste preparation 304 and base varnish produced by the base varnish production 306. The coating material production 308 may be connected via pipes with the base varnish production 306 and the pigment paste preparation 304 to allow supply of produced base varnish and pigment pastes. The coating material production 308 may be connected to material storage via lines or pipes and the amount of respective intermediate product(s) may be supplied using sensors to allow the operating system 208 to control the feed of intermediate product(s) based on sensor data. The coating material production 308 may be controlled by the operating system 208 described in relation to FIG. 2 based on received material demand data or on the received bills of materials.

The chemical production 204 may further include a packaging unit (not shown) for packaging the coating material(s) produced by coating material production 308. The coating materials may be packaged into containers and the containers may be stored in a material storage.

FIG. 3A illustrates an embodiment for a system boundary of the chemical production, which includes the resin production 302. The inbound materials stream forms the entry point into the chemical production. The coating materials form the exit point out of the chemical production.

FIG. 3B illustrates another embodiment for the system boundary of the chemical production, which excludes the resin production 302. The resin feed and further inbound material feed form the entry point into the chemical production. The coating materials form the exit point out of the chemical production. The chemical productions and the system boundaries illustrated in FIGS. 3A and 3B are examples and should not be considered limiting.

FIG. 3C illustrates a part of a discrete production producing discrete products from different materials. The discrete production 322 comprises a system boundary. In this example, the inbound material streams form the entry point into the discrete production 322.

Inbound material streams may include coating materials, such as coating materials produced by chemical production 204 of FIG. 3A or 3B, and further chemical materials, chemical products or components. The inbound materials may be supplied by tiers 1 and/or tiers 2 as illustrated in FIG. 3D.

The discrete products produced from the discrete production 310 form the exit point out of the discrete production 310. The chemical discrete production 310 may include different production chains for assembly of different components of the discrete product.

FIG. 3D illustrates a part of a supply chain for producing a discrete product, such as a car, from chemical product(s), such as a coating material, and further chemical materials, chemical products and components.

The example of FIG. 3D illustrates two tiers and an original equipment manufacturer. Tier 1 may be a chemical producer operating chemical production 314. The chemical production 314 may correspond to the chemical production 204 described in relation to FIG. 2. The chemical production 314 may be associated with a system boundary 312. The system boundary 312 may signify the physical boundary of the chemical production 314. The inbound material(s) entering the chemical production 314 at any stage of the production, or the system boundary 312 of the chemical production 314 may signify entry points to the chemical production 314. On entry of inbound material(s), material data may be accessed for each inbound material entering the chemical production 314. The material data may be received and stored by the method as described in relation to FIG. 5. Chemical product(s), such as coating materials, may be produced from inbound material(s) and/or intermediate product(s) by the chemical production 314. The intermediate product(s) may be produced by the chemical production 314 from inbound material(s) and or from other intermediate products previously produced by the chemical production 314. The preference data associated with the produced chemical product(s) may be determined as described in relation to FIGS. 11 to 14B and may be linked to the produced product.

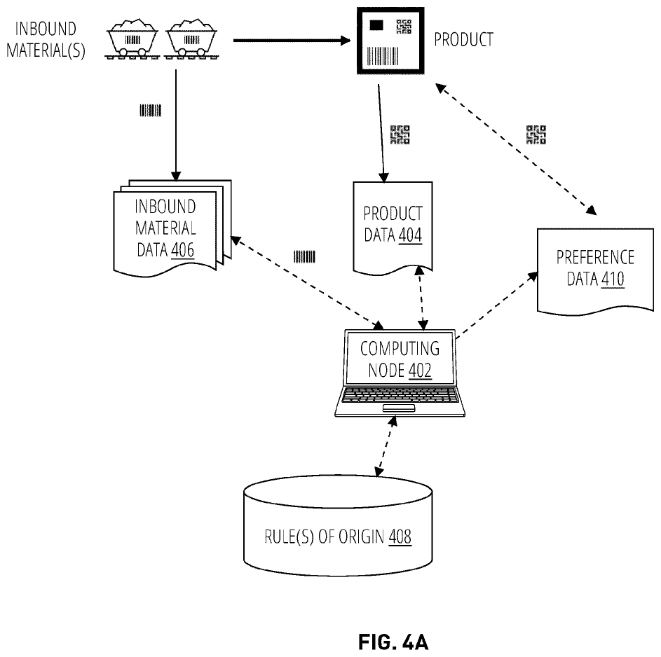

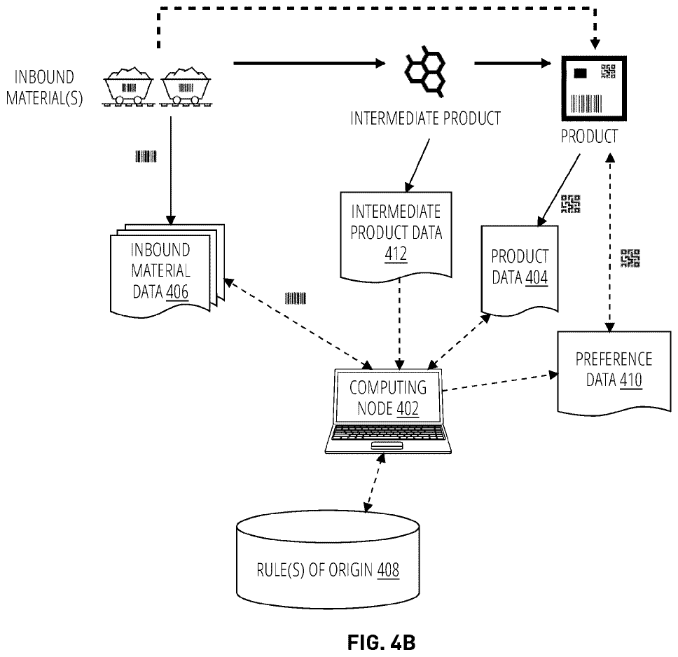

Linking of the determined preference data to the product may be performed, for example, by linking said preference data to the product identifier associated with the produced product as described in relation to FIGS. 4 and 5. A product passport including a decentral identifier and data related to product data may be generated, said product data including the generated preference data associated with the chemical product as described in relation to FIG. 5. The latter may allow to provide the product data via a data providing service to an upstream participant of the supply chain as described in relation to FIG. 5. For instance, tier 2 may retrieve the product data including the generated preference data using the decentral identifier and the data related to the product data via a data consuming service. The retrieved product data containing the preference data may be used to generate preference data for products produced by tier 2 as described in relation to FIGS. 11 to 14B.

The produced chemical product(s) associated with the preference data may be provided to the next tier as inbound material. In the illustrated example, tier 2 may be a production 318 producing discrete products from supplied chemical product(s) and other components or materials. Discrete products may be any products associated with distinct physical units. Discrete manufacturing in contrast to process manufacturing uses such discrete products to assemble other discrete products. The chemical to discrete production 318 may be associated with a system boundary 316 as described above. Like the chemical production 314, the chemical to discrete production 318 may receive access-for instance via a data consuming service-inbound material data associated with the chemical product(s) (inbound) produced by of the chemical production 314. The inbound material data may contain the generated preference data associated with the received chemical product(s). Discrete outbound product(s) may be produced by the chemical to discrete production 318. The chemical to discrete production 318 may generate, for instance using an operating system of the chemical to discrete production 318, preference data associated with produced discrete product(s) as described in FIGS. 11 to 14B. The produced discrete product(s) may be linked to the generated preference data as described above and said preference data may be provided via a data providing service to the original equipment manufacturer as described previously.

The outbound discrete product(s) produced by the chemical to discrete production 318 may be provided as inbound material to an original equipment manufacturer producing end products. As described previously, the original equipment manufacturer may retrieve inbound material data associated with the received inbound material(s), such as discrete product(s) received from tier 2, and may use the preference data contained in said received material data to determine the preference data associated with the produced end products. The determined preference data may be linked to an end product identifier specifying an end product of a product supply chain.

Use of inbound material data containing preference data associated with the respective inbound material allows to determine the preference data of product(s) produced from said inbound material from the preference data contained in the accessed inbound material data without having to perform any time-consuming and error prone data integration of the preference data associated with the provided inbound material(s). Moreover, the inbound material data accessed via a data consuming node from a decentral network allow for simplified and customizable data sharing or exchange from chemical industry to further supply chain participants. This way, a more reliable and efficient determination of preference data associated with product(s) produced from supplied materials by upstream participants of the supply chain can be achieved, while the inbound material data remains in the ownership of the supplier supplying the upstream participant. By combining the data related to inbound material data directly with the decentral identifier and optionally one or more authentication mechanisms more reliable and secure data sharing and exchange can be provided. Further use of one or more authorization mechanisms allows to conduct the data sharing or exchange in a more flexible manner with multiple data consuming services from different participants of the supply chain accessing the inbound material data. By generating preference data for produced product(s) and attaching said generated preference data as a digital asset to such produced product(s), production of further product(s) using said produced product(s) as inbound material may be steered or controlled based on the associated preference data (e.g. the associated digital asset including the preference data). For instance, the flow of produced products delivered by the product producer to a downstream participant of the product ecosystem may be controlled or steered by the downstream participant based on associated preference data such that further products produced from such received product flow may fulfil target preference data.

FIG. 4A illustrates an example of an apparatus for generating preference data associated with a product produced from at least one inbound material.

In this example, one or more of inbound material(s) is/are provided. At least one chemical product may be produced from the provided inbound material(s) by a chemical production, such as the chemical production of FIGS. 3A to 3C. Product data may be collected by one or more data collector(s) during and/or after production of the product and may be stored on a data storage medium. The collected product data may be interrelated with a product identifier to allow retrieval of said product data based on the product identifier.

Computing node 402 may be part of an operating system of a production producing the product from the one or more inbound materials. The computing node 410 may be laptop, a desktop computer or any other computing device comprising at least one computing node. The computing node 402 may receive a request to generate preference data associated with the product. Said request may contain product data 404, such as the product identifier, product composition data or other data mentioned previously. The request may be triggered by a bar code reader or scanner scanning the physical identifier, such as a bar code, a QR code or an embossed code, present on the physical entity of the product, for example on the packaging of the product. For instance, the packaging line may comprise a detector detecting the physical identifier on each package. Based on such recognition, the operating system of the chemical production (see FIG. 2) may determine the product identifier associated with the physical identifier and may generate the request by retrieving the respective product data associated with the determined product identifier. The product data may be retrieved from a database, such as a company's ERP system, using the determined product identifier, such as a unique ID, a product name, etc.

Each provided inbound material may be associated with inbound material data 406 containing preference data, such as the origin of the material, the preference status of the material and optionally any non-preferential substances contained in the material, associated with said inbound material. The preference data may conform to the supplier declaration associated with the respective inbound material.

The inbound material data 406 may further include the data described previously, such as physical data associated with the inbound material, inbound material declaration data, inbound material safety data, certificate of analysis data associated with the physical entity of the inbound material, inbound material emission data, recyclate content data associated with the physical entity of the inbound material, bio-based content data associated with the physical entity of the inbound material, inbound material production data, and combinations thereof.

A data consuming node (not shown) may be used to gather the inbound material data associated with the received inbound material(s) from a decentral network as described in relation to FIGS. 1D, 5 and 6. Gathering at least part of the material data via a decentral network using a data consuming node allows computing node 402 to use the preference data associated with the inbound materials without any previous data integration steps, thus avoiding errors occurring upon integration of data into existing systems to generate preference data.

The retrieved inbound material data may be stored on a data storage medium, such as a database or dedicated storage, associated with the data consuming service The retrieved inbound material data may be stored on a data storage medium, such as a database, associated with the data consuming service using respective inbound material identifier(s). Computing node 402 may retrieve the preference data from the retrieved inbound material data. For this purpose, computing node 402 may determine inbound material identifier(s) associated with the inbound material(s) used in the production of the product based on the received product data 404 and may use the determined inbound material identifier(s) to retrieve the respective preference data associated with the determined identifier(s).

Computing node 402 may be connected to a database 408 containing rule(s) of origin. Computing node 402 may be configured to generate preference data associated with the produced product 410 from the received product data 404, the preference data retrieved from the inbound material data 406, and rule(s) of origin retrieved from database 408. The preference data may be generated by computing node 402 using the method described in relation to FIG. 11 later on. The generated preference data 408 may be provided via a communication interface, for example to a display device for display on the screen. The generated preference data 410 may be interrelated with the product identifier associated with the produced product and may be stored on a data storage medium, such as a database. Said stored preference data 410 may be used, along with further product data, to generate a product passport. The product passport may include the preference data, a digital product identifier and optionally further product data. The digital product identifier may include decentral identifier(s) associated with the product. The product passports may be associated with a digital access element. The digital access element may include representation for accessing the product passport or parts thereof. The digital access element may allow access to the associated product passport or parts thereof. The digital access element may be stored in a decentral registry associated with the data owner of the product passport. The data owner may control access to such decentral registry, for example via an associated decentral data providing network node. Examples of such digital access elements are given in FIGS. 7 and 8.

Upon producing the product or upon exiting of the product of the chemical production, the product passport(s) associated with produced product(s) may be generated. The product passport(s) may be generated by an apparatus for generating product passports(s). The apparatus may correspond, for example to computing node 402 or any other computing node of or associated with the operating of chemical production The apparatus may be configured to receive a request to provide the decentral identifier. A requestor may be configured generate the request for the decentral identifier. Said request may be triggered by a labelling system such as a QR Code generator. The request to provide the decentral identifier may be provided to a digital ID generator configured to generate the decentral identifier. For instance, a computing node (that acts as a DID owner's management module, user agent, ID hub and/or certification issuer) may receive an indication to generate the decentral identifier. The indication may include providing at least one authentication mechanism or selecting at least one of multiple authentication mechanisms. The decentral ID generator may provide the generated digital identifier to a decentral ID provider. The decentral ID generator and the decentral ID provider may be separate units or may be combined within a single unit.

The decentral ID provider may provide the decentral identifier to the requestor. The requestor may be configured to associate the received decentral identifier with the produced product. The requestor may contain an ID assignor configured to assign the received decentral identifier to the physical identifier. Such association may include encoding the decentral identifier into a code and providing the code for labelling the product. Such association may include linking the decentral identifier to a physical identifier present on the product. This way a physical identifier may be provided that relates the physical entity of the product with the provided decentral identifier.

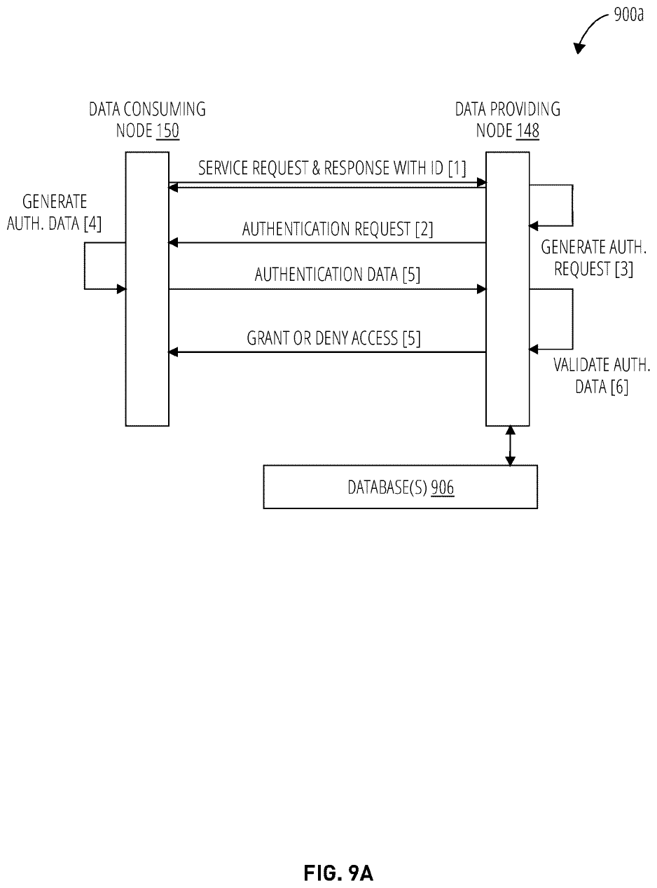

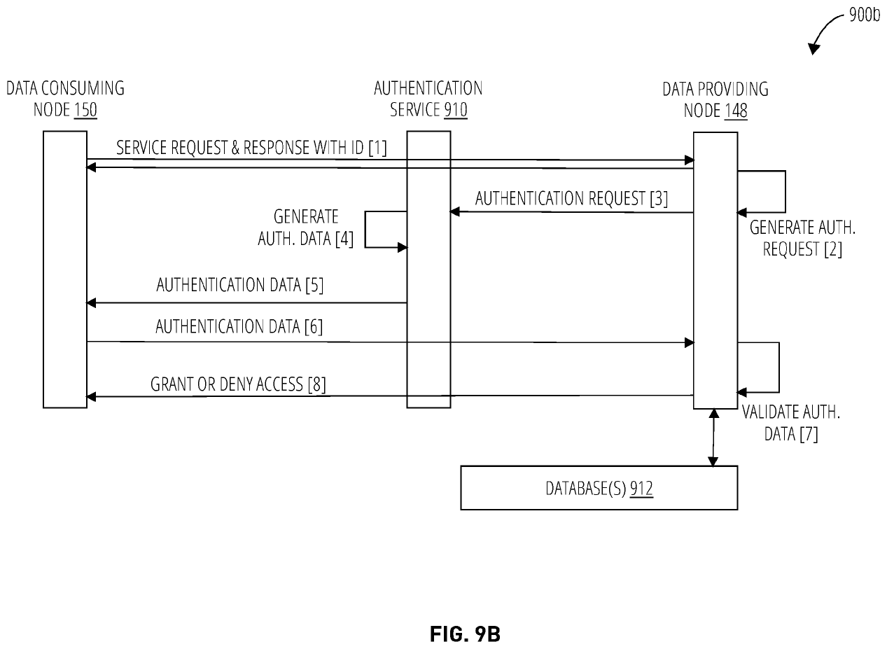

The decentral ID provider may provide the decentral identifier to a product passport generator configured to generate the product passport based on the decentral identifier received from decentral ID provider and product data. The generated product passport may include the digital identifier and product data. The product passport may include or be related to one or more authentication mechanisms associated with the decentral identifier and/or the product data. The authentication mechanisms may be used as described for example in the context of FIG. 9A. The product passport may relate to one or more authorization mechanisms associated with the decentral identifier and/or the product data. The authorization mechanisms may be used as described for example in the context of FIG. 9B. The product passport may be stored on a dedicated storage associated with the data owner, such as the product producer. The dedicated storage may be associated with a data providing node configured to provide product data via a decentral network upon request by a data consuming node, for example as described in the context of FIG. 5.

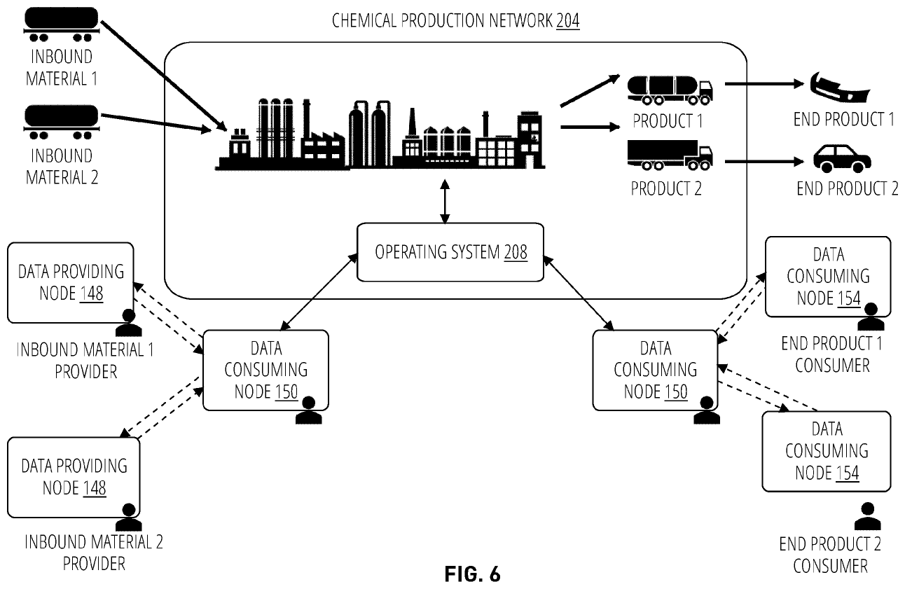

The product passport generator may further be configured to generate a digital representation associated with the product. The digital representation may be denoted as access element hereinafter. The generated digital representation may include the digital identifier and a representation for accessing the product data (e.g. access data). Access data may include one or more digital representation(s) pointing to product data or parts thereof. The access element may include or be related to one or more authentication mechanisms associated with the decentral identifier and/or the access data. The authentication mechanisms may be used as described for example in the context of FIG. 9A. The digital access element may relate to one or more authorization mechanisms associated with the decentral identifier and/or the access data. The authorization mechanisms may be used as described for example in the context of FIG. 9B. At least a portion of data contained in the digital access element may be propagated to a decentral registry associated with the data providing node providing the associated product data. The decentral registry may be under control of the data owner of the product data. The access element may be used to access at last a part of the product passport, for example as described in the context of FIG. 5 and FIG. 6.

The generated product passport may be provided to a product passport provider. The product passport provider may be configured to provide the product passport for access by a data consuming node of a decentral network, such as decentral network 166 described in the context of FIG. 6. The product passport provider may control the access by the data consuming node. The product passport provider may be a data providing node associated with the product production. The product passport provider may be associated with or under control of a data owner of the product data associated with the generated product passport. The data owner may be the product producer.

FIG. 4B illustrates an example of an apparatus for generating preference data associated with a product produced from at least one inbound material and/or at least one intermediate product.

In this example, one or more of inbound material(s) is/are provided. At least one intermediate product may be produced from the provided inbound material(s). The product may be produced from the intermediate product(s) and optionally one or more inbound material(s). Intermediate product data may be collected by one or more data collector(s) during and/or after production of the intermediate product and may be stored on a data storage medium. Product data may be collected by one or more data collector(s) during and/or after production of the product and may be stored on a data storage medium. The collected intermediate product data may be interrelated with an intermediate product identifier to allow retrieval of said intermediate product data based on the intermediate product identifier. The collected product data may be interrelated with a product identifier to allow retrieval of said product data based on the product identifier.

Computing node 402 may receive a request to generate preference data associated with the product as described in relation to FIG. 4A.

A data consuming node (not shown) may be used to access inbound material data associated with the received inbound material(s) via a decentral network as described in relation to FIGS. 5 and 6. The preference data contained in said accessed and optionally stored inbound material data may be retrieved by computing node 402 as described in relation to FIG. 4A.

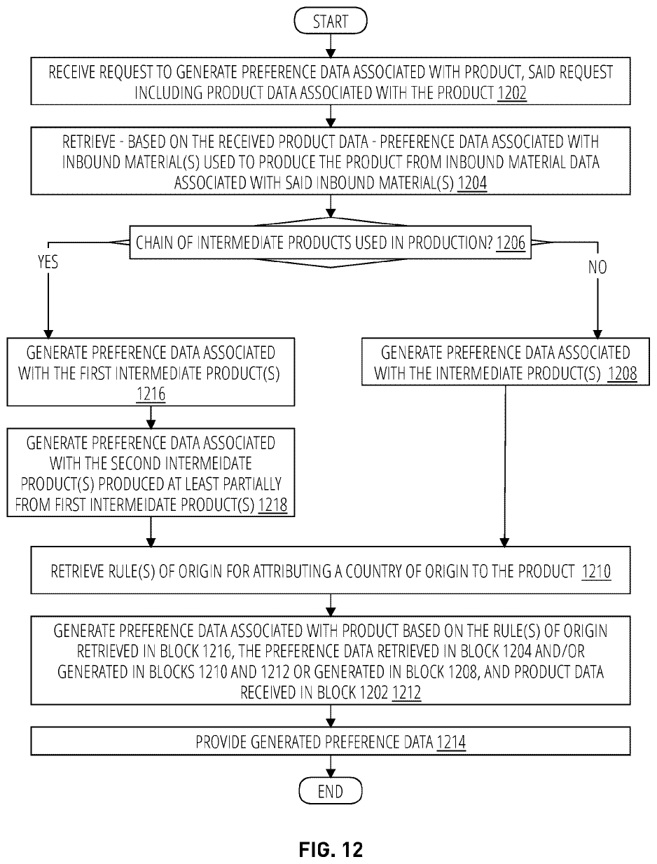

Computing node 402 may be connected to a database 408 containing rule(s) of origin. Computing node 402 may be configured to generate preference data for the intermediate product(s). Computing node 402 may be configured to retrieve intermediate product data based on the product data contained in the received request. For instance, the product composition data may be used to determine intermediate product data, such as intermediate product composition data. Said data may be used to determine inbound material(s) used to produce the intermediate product. Moreover, said data may be used to determine whether preference data for the respective intermediate product has been determined previously. Computing node 402 may be configured to generate preference data associated with the intermediate product(s) from the retrieved preference data associated with inbound material(s) used to produce the intermediate product(s), the retrieved intermediate product data and the rules of origin retrieved from database 408. The preference data may be generated by computing node 402 using the method described in relation to FIG. 12 later on. Computing node 402 may be configured to generate preference data for a second intermediate product produced at least in part from a first intermediate product based on preference data previously generated by computing node 402, optionally retrieved preference data associated with inbound materials used to produce the second intermediate product, the retrieved intermediate product data and the rules of origin retrieved from database 408. The preference data may be generated by computing node 402 using the method described in relation to FIG. 12 later on. The first and the second intermediate products are produced by the same chemical production, such as the production described in FIGS. 3A and 3B. Computing node 402 may be configured to generate preference data associated with the produced product based on the retrieved rule(s) of origin, the retrieved preference data associated with the inbound material(s) and/or the generated preference data associated with the intermediate product(s), and the received product data 406. The preference data may be generated by computing node 402 using the method described in relation to FIG. 12 later on. The generated preference data 408 may be provided via a communication interface, for example to a display device for display on the screen. The generated preference data 410 may be interrelated with the product identifier associated with the produced product and may be stored on a data storage medium, such as a database. Said stored preference data 410 may be used, along with further product data, to generate a product passport. Examples of such a product passport are given in FIGS. 7 and 8.

FIG. 5 illustrates an example of a system for producing at least one product associated with preference data.

The system may include a production 204, such as a chemical production or a chemical production network (see for example FIGS. 3A and 3B), and an operating system 208. Inbound materials 202 may be provided to the production 204. The inbound materials 202 may enter the system boundary of the production 204 at the entry point, such as a resin plant, pigment paste plant, coating material production or a material storage. The inbound materials 202 may be used in the production 204 to produce one or more intermediate product(s) and/or one or more product(s) from the inbound materials. Product(s) may be provided on exit points of the production 204. Intermediate products and products may include chemical products, such as pigment pastes, base varnishes, thinners, rheology modifying agents and coating materials. The inbound materials may be associated with decentral identifier(s). The decentral identifier(s) may be linked to or may be associated with inbound material data.

Inbound material data associated with the inbound materials may be accessed, for example by a data consuming node 150 from a data providing node 148 via a decentral network, using the decentral identifier(s) associated with the inbound material(s) 202. Data consuming node 150 and data providing node 148 may be part of a decentral network, such as decentral network 166 illustrated in FIG. 1D. Data providing node 148 may be associated with an entity producing inbound material(s), such as input material supplier 134. Data consuming node 150 may be associated with an entity consuming data, such as a chemical product producer 130 using inbound material(s) to produce chemical products and consuming material data associated with such inbound materials. The inbound material data may be retrieved on, prior or after providing of the one or more inbound material(s) at entry points to the production 204.

The decentral identifier may be assigned to a physical identifier connected to the respective provided inbound material. The connection of the physical identifier with the respective inbound product may be provided by means of a physical connection to the physical entity of the respective inbound material. The physical identifier may be physically attached to the respective inbound material via an identifier element, such as markers embedded in materials, a bar code, a QR-Code, a tag like a RFID tag or similar physical arrangement that allows to digitally identify the chemical product.

The physical identifier may be provided from a sensor which reads the physical identifier element connected to the respective inbound material. The sensor data may be provided to operating system 208 and operating system 208 may determine the decentral identifier using the provided sensor data. The provided sensor data may include the physical identifier. The provided sensor data may include a digital material identifier associated with the inbound material. For instance, operating system 208 may be able to directly determine the decentral identifier from the received sensor data. The determined decentral identifier may be stored in a database associated with operating system 208. In another instance, operating system 208 may retrieve the decentral identifier through the decentral network. Operating system 208 may be configured to generate query data to query the decentral network 166 for decentral identifier(s) associated with the provided sensor data. The query data may include at least a part of the provided sensor data, such as the physical identifier or the digital material identifier. The query data may be used by data consuming node 150 connected to operating system 208 to query the decentral network 166. The data consuming node 150 may be associated with a data user, such as the production 204 or the legal or natural person operating production 204. The query data may be used to query decentral registries associated with data providing nodes operated by data owners, such as material data owners. The decentral registries may store data related to the material data. The digital representations may include decentral identifier(s) and a representation for accessing the respective material data associated with the decentral identifier(s). The decentral identifier(s) received by data consuming node 150 in response to providing the query data to the decentral network 166 may be provided by data consuming node 150 to operating system 208.

Operating system 208 may use the decentral identifier to retrieve a DID document associated with said decentral identifier(s) and may provide the data related to the inbound material data, such as end point address(es) of a data providing node associated with inbound material data linked to such decentral identifier(s), contained in said DID document to the data consuming node 150. Operating system 208 may be configured to request the DID document associated with said decentral identifier(s), for example via a DID resolver service. The DID resolver service may resolve the endpoint addresses included in the DID document based on the received decentral identifier(s) and may provide the resolved endpoint address(es) to operating system 208.

Data consuming node 150 may be configured to gather data related to the inbound material data, such as such as representations for access to the inbound material data using the decentral identifier(s). The representation(s) for access may include end point address(es) of data providing node(s), such as data providing node 148, associated with the respective inbound material data, from a database of a decentral network, such as the decentral registry 514. The decentral registry may store access elements include the data related to the inbound material and the decentral identifier associated with the material. The access elements may be associated with respective inbound materials via the decentral identifier(s). The decentral registry 514 may be associated with the data owner of the inbound material associated with such access element. The decentral registry 514 may be associated with data providing node 148 associated with or under control of the data owner of the inbound material data, such as input material supplier 134. Access to the decentral registry 514 may be controlled by the data owner via associated data providing node 148.

Based on the received decentral identifier(s) and the data related to the material data, a request to access the inbound material data associated with the respective decentral identifier(s) may be triggered by the data consuming node 150. The decentral identifier(s) may be provided to the data providing node 148 associated with the producer of the respective inbound material 202. In addition, authentication and/or authorization information may be provided. The access to the inbound material data may be based on an owner identifier associated with the data owner, such as the data owner of the respective inbound material data. The access to the inbound material data may be based on a decentral participant identifier associated with or related to the data consuming node 150. The decentral participant identifier may be associated with the entity operating the data consuming node 150. The decentral participant identifier may uniquely identify a participant within the decentral network 166. The inbound material data 406 may be exchanged between an interface of a data owner and an interface of a data user via the data providing node 148 and the data consuming node 150. The data providing node 148 and the data consuming node 150 may each comprise a data connector to allow a secure and trusted material data exchange. Exchange or sharing of data may be conducted according to predefined authorization mechanisms as described in relation to FIGS. 8A and 8B.

The request may be authenticated and/or authorized to access the inbound material data associated with the decentral identifier. Based on successful authorization and/or authentication access to the inbound material data associated with decentral identifier may be granted by data providing node 148. For access to the inbound material data 406, the decentral identifier(s) received by data providing node 148 may be used by said service to retrieve the inbound material data associated with the decentral identifier(s). The inbound material data may be retrieved from a dedicated storage 506 associated with the data providing node 148 upon successful authentication and authorization of data consuming node 150. The inbound material data 406 associated with the decentral identifier(s) provided to the data providing node 148 may be provided to the data consuming node 150. The inbound material data 406 provided by the interface of the data owner may be associated with authorization mechanisms such as usage policies specifying authorization rules such as data usage rules. The inbound material data 406 provided by the interface of the data owner via the data providing node 148 may be accessed by the interface of the data user according to the usage policies attached to the inbound material data 406 provided by the interface of the data owner. This may entail contract negotiation between the services and the inbound material data 406 may only be provided upon successful completion of the negotiation. For example, the preference data contained in said material data 406 may be access-restricted (i.e. may be associated with an authorization scheme) and access may only be granted upon the data consuming node 150 agreeing on usage terms for said access-restricted data proposed by the data providing node 148.

The data consuming node 150 may store the inbound material data 406 received from data providing node 148 in a data storage 508 connected to said data consuming node 150 according to the data usage rules.

The inbound materials 202 fed to the production 204 may be used to produce one or more intermediate product(s) and/or one or more product(s). For example, inbound materials may be raw materials used to produce a coating material and the production 204 produces coating materials as described in relation to FIGS. 3A and 3B. Provision of inbound material(s) required to produce the intermediate product(s) and/or product(s) may be controlled and/or managed by operating system 208 based on material demand data as described in relation to FIG. 2. Provision of intermediate product(s) required to produce the further intermediate product(s) and/or product(s) may be controlled and/or managed by operating system 208 based on material demand data as described in relation to FIG. 2.

The produced products may be provided with a product identifier. The product identifier may be a tag attached to the physical entity of the product or may be a virtual identifier contained in the production data. The tag may be scanned and part of the product data (i.e. the product identifier) may be provided to the operating system 208, for example via a computing interface. Providing the product identifier to the operating system 208 may be triggered by a request to generate preference data 410 for the produced product(s). Said request may be received by the operating system 208 and the operating system 208 may trigger provisioning of the product identifier. Said request may be contained in the production order ordering the produced products, for example preferential data is required to be provided for the produced products or if the produced products are to be delivered to one or more predefined countries. Production order(s) may be received by the chemical operation operating system 208 and the chemical operation operating system 208 may determine whether preference data is to be generated for the produced product. Providing the product identifier to the operating system 208 may trigger a request to generate preference data 410 for the produced product(s). The request may contain product data, such as the product identifier, product composition data, a customs tariff classification or a combination thereof. Triggering generation of preference data may also entail retrieving product data contained in the request. For instance, triggering generation of preference data may result in the operating system 208 retrieving the product data to be contained in the request.

Operating system 208 may retrieve the inbound material data 406 associated with the respective inbound materials used to produce the product. The inbound material data 406 may be retrieved from data storage 508 using the decentral identifier(s) or a material identifier(s) associated with the inbound material(s) used to produce the product. The used inbound material(s) may be determined by operating systems 208 based on the bill of material or recipe associated with the received product identifier. Operating system 208 may generate preference data for intermediate product(s) used to produce the product by retrieving intermediate product data based on the received product data. The inbound material data 406 associated with inbound materials used to produce the intermediate product(s) may be determined from the intermediate product data and may be retrieved from data storage 508. Operating system 208 may retrieve previously determined preference data associated with intermediate product(s) used to produce the product, for example for a database, such as data storage 408. For instance, a product may be produced from a second intermediate product which in turn may be produced from a first intermediate product. In this case, the preference data of the first intermediate product may be determined using inbound material data as described in relation to FIG. 12 later on. The preference data of the second intermediate product may be determined using the determined preference data of the first intermediate product.

Operating system 208 may further retrieve rules of origin from a data storage 508. Said data storage may be the same data storage storing the inbound material data 406 or a different data storage (not shown). The rule(s) of origin may be retrieved by operating system 208 based on country data. The country data may be retrieved by operating system 208 from a data storage using the product identifier, may be retrieved from the production order or may be provided to the operating system 208, for example by a user triggering generation of preference data 410. The rule(s) of origin may be retrieved by operating system 208 based on the product identifier. Operating system 208 may retrieve further product data, for example price data and/or customs tariff classification using the product identifier. Said data may also be contained in the received request.

Using the inbound material data 406 and/or the preference data generated for intermediate product(s) and/or the preference data retrieved for intermediate product(s), the rule(s) of origin and the product data, operating system 208 may generate preference data 410 associated with the product as described in relation to FIGS. 11 to 14B. The generated preference data 410 may be interrelated with the product identifier and may be stored in a data storage. The generated preference data may be interrelated—optionally along with other product data—with a decentral identifier to generate a product passport as described in relation to FIG. 4A. Said product passport may be provided to downstream participant the physical entity of the produced product is supplied to. The product passport may signify a digital asset associated with the physical product. The generated preference data interrelated with the product identifier may be provided via the product passport to the downstream participant the physical entity of the produced product is supplied to.

By generating such digital asset associated with produced product(s), production of further product(s) using said produced product(s) as inbound material may be steered or controlled based on the associated preference data included in such digital asset(s). For instance, the flow of produced products delivered by the product producer to a downstream participant of the product ecosystem may be controlled or steered by the downstream participant based on associated preference data such that further products produced from such received product flow may fulfil target preference data.

FIG. 6 illustrates schematically an example of a method or apparatus for providing preferential data associated with inbound material(s) and product(s) across value chains via a decentral network.

In the example of FIG. 6, a fully connected value chain including the chemical production network 204 is illustrated. In this example, the inbound material provider(s), the product producer and the end product producer may be connected via a decentral network as described in the context of FIG. 1C and FIG. 5. Preference data may be provided via the ID based schema described in the context of FIG. 5 in the form of passports or digital assets associated with the physical entity of the inbound material, the product, any intermediate product or the end product.

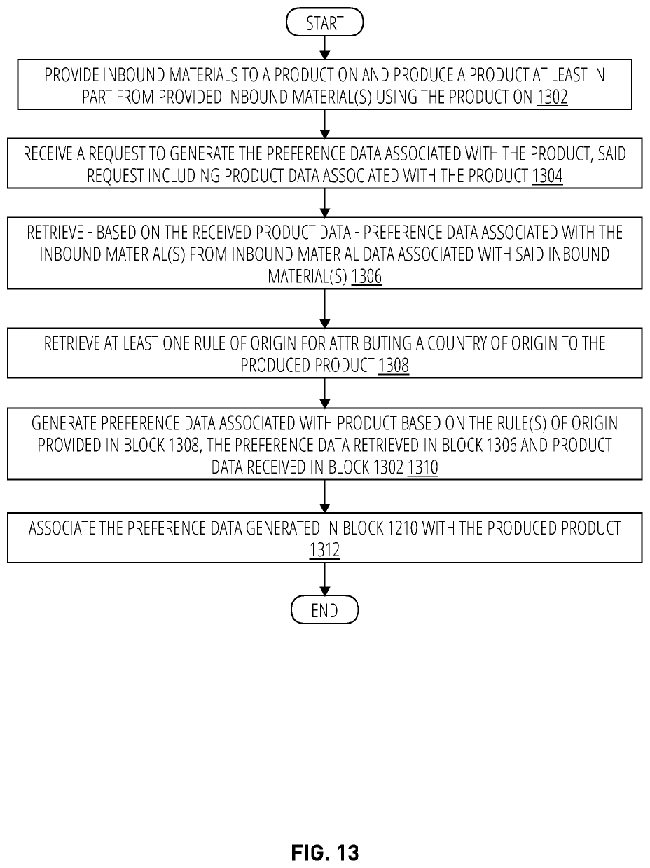

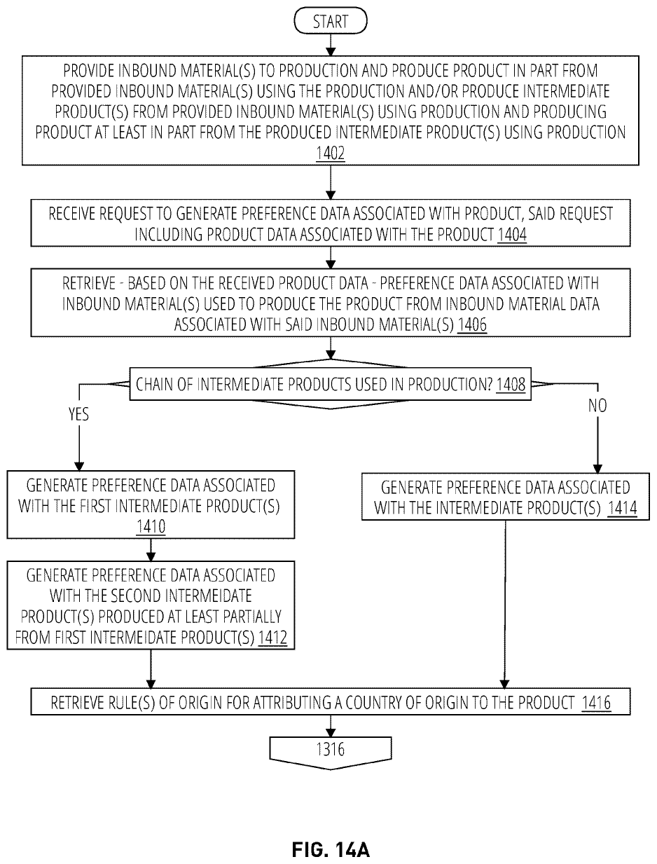

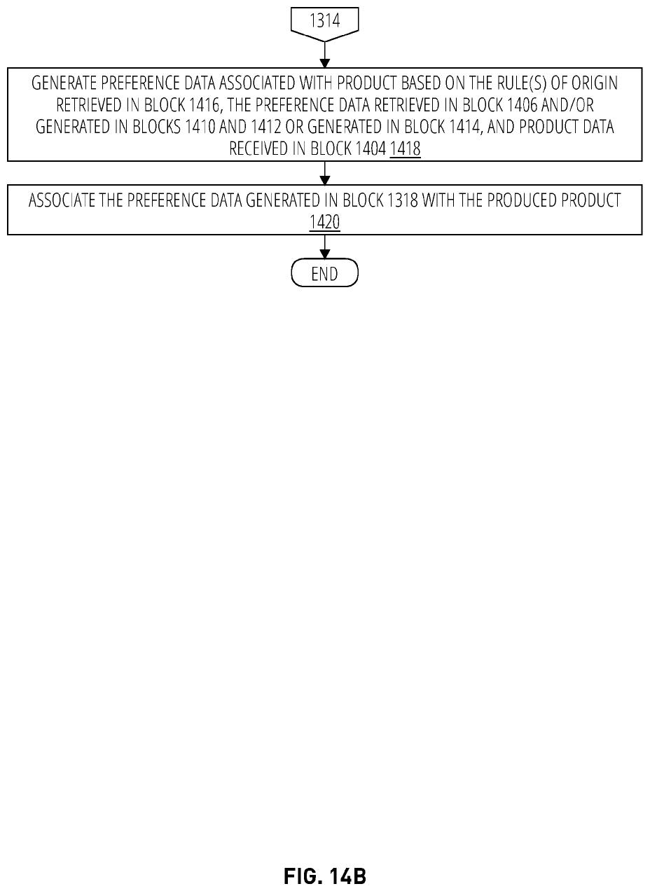

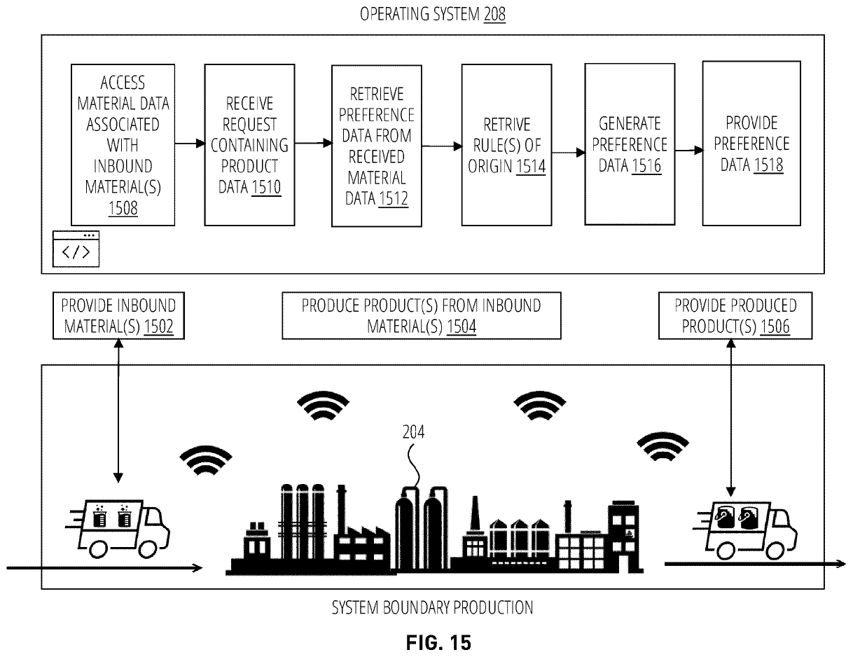

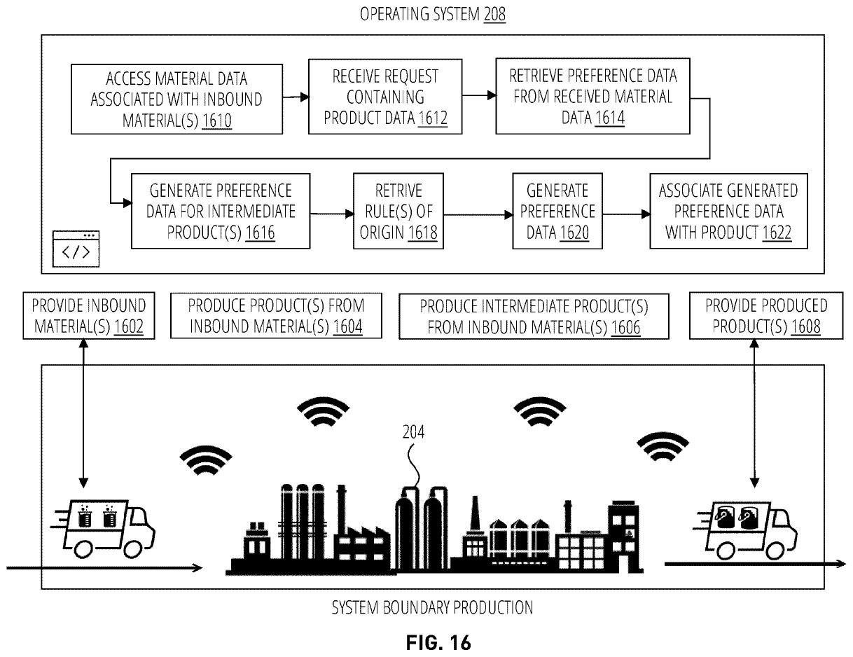

The inbound material provider(s) may provide the inbound material(s). The inbound material(s) may include chemical materials, discrete materials or a combination thereof (see for example FIG. 3D). The preference data associated with said inbound material(s) may be provided through the data providing node(s) 148 associated with the inbound material provider(s) and connected to the decentral network as described in the context of FIG. 5. The product producer may produce product at least in part from the inbound material(s) provided to the chemical production network 204. The product producer may produce intermediate product(s) from part of the provided inbound materials. The product producer may use the produced intermediate product(s) at least in part to produce the product. The product producer may access the preference data associated with the inbound material(s) used to produce the product through a data consuming node 150 connected to the decentral network as described in the context of FIG. 5. Said preference data may be retrieved from a data providing node(s) 148 associated with the respective inbound material provider(s). The product producer may generate the preference data of the produced product via the operating system 208 as described in the context of FIGS. 2 to 4B. The product producer may assign generated preference data to the produced products as described in the context of FIGS. 13 to 14B. The product producer may provide the preference data associated with the produced product(s) through the data providing node 150 connected to the decentral network as described in the context of FIG. 5. The product consumer or the end product producer may access the preference data associated with the produced product(s) through the data consuming node 154 associated with the respective product consumer or the end product producer and being connected to the decentral network as described in the context of FIG. 5.

The respective preference data owners in this example may be the inbound material producer, the product producer and the end product producer. The data owner may comprise any entity generating data. The data generating node may be coupled to the data owner or the entity owning or producing physical inbound material(s), product(s), intermediate product(s) or end product(s) from or for which data is generated. The data may be generated by a third-party entity on behalf of the entity owning physical inbound material(s), product(s), intermediate product(s) or end product(s) from or for which data is generated.

In the example of FIG. 6, the decentral identifier may relate to the end product. Such decentral identifier may be provided to the value chain participants. Via the end product, specific decentral identifier preference data associated with the end product produced from the product may be generated across the production chain and assigned to the end product specific decentral identifier. For example, the preference data associated with the end product may be generated from the preference data associated with the product.

This way the preference data of a produced product may be readily determined using the preference data of material(s) used to produce the product while allowing the participants of the supply chain to control the information flow. In addition, the preference data can be handled according to the individual participants needs by production operating systems as described in the context of FIG. 2.

FIG. 7 shows an example of ID-based owner data, ID-based digital representation of material data or product data and a decentralized identity manager. The digital representation may signify an access element for accessing the material data or the product data, respectively.

The ID may be a decentralized ID (DID). The ID-based digital representation may be a DID document associated with the DID. The ID-based owner data may include an ID associated with a subject such as inbound material data or product data and may include authentication mechanisms. The ID-based owner data may include owner data that is electronically owned and controlled by the DID owner. In this context electronically owned may refer to data that is stored in an owner repository or wallet. Such data may be securely stored and/or managed on an organizational server or client device. The ID-based owner data may include a DID, a private key and a public key. The ID-based owner may own and control the DID that represents an identity associated with the DID subject, a private key and public key pair that are associated with the DID. DID may be understood as an identifier and authentication information associated with or uniquely linked to the identifier.

The DID subject may be a raw material, a basic substance, a chemical product, an intermediate product, a component, a component assembly or an end product. The DID subject may be a machine, a system, or a device used for producing the raw material, the basic substance, the chemical product, the intermediate product, the component, the component assembly or the end product, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce chemicals. The DID owner may be a downstream participant in the supply chain of the chemical manufacturer such as a customer that consumes chemicals to produce the intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the DID subject and/or the DID owner. Preferably, the identifier is unique to the DID subject and/or DID owner. The identifier may be unique at least within the scope in which the DID is anticipated to be in use. The identifier may be a locally or globally unique identifier for the raw material, the precursor, the basic substance, the chemical product, the intermediate product, the component, the component assembly, the end product or a collection thereof; the machine, the system, or the device used for producing the raw material, the basic substance, the chemical product, the intermediate product, the component, the component assembly or the end product, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did: example: ebfeb1f712ebc6f1c276e12ec21. The DID may be decentralized independent of a centralized, third-party management system and under the control of the DID owner.

The digital representation as DID document may be associated with the DID. Accordingly, the digital representation may include a reference to the DID, which is associated with the DID subject that is described by the DID document. The DID document may also include an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The digital representation may include one or more representations that digitally link to the inbound material data or product data, e.g. by way of service endpoints. A service endpoint may include a network address at which a service operates on behalf of the DID owner. In particular, the service endpoints may refer to services, such as data providing node(s) of a decentral network, of the DID owner that give access to inbound material data or product data. Such services may include services to read or analyze inbound material data or product data. Inbound material data or product data may include preference data associated with the inbound material or product and may further include chemical product declaration data, chemical product safety data, certificate of analysis data, emission data, product carbon footprint data, product environmental footprint data, chemical product specification data, product information, technical application data, production data or combinations thereof.

The digital representation may include various other information such metadata specifying when the digital representation was created, when it was last modified and/or when it expires.

The DID and the digital representation may be associated with a data registry node such as a centralized data service system or a decentralized data service system, e.g. a distributed ledger or blockchain or a decentralized file system. Possible blockchain systems include Quorum, Hyperledger Fabric. The distributed ledger or blockchain may be used to store a representation of the DID that points to the material passport or product passport. A representation of the DID may be stored on distributed computing nodes of the distributed ledger or blockchain. For example, DID hash may be stored on multiple computing nodes of the distributed ledger and point to the location of the material passport or product passport. In some embodiments, the material passport or product passport may be stored on the distributed ledger. Alternatively, in other embodiments the DID document may be stored in a data storage that is associated with the distributed ledger or blockchain or a decentralized file system.

The distributed ledger or blockchain may be any decentralized, distributed network that includes various computing nodes that are in communication with each other. For example, the distributed ledger may include a first distributed computing node, a second distributed computing node, a third distributed computing node, and any number of additional distributed computing node. The distributed ledger or blockchain may operate according to any known standards or methods for distributed ledgers. The distributed ledger or blockchain 1806 may include known technology stacks like Bitcoin (see e.g. Bitcoin documentation of Nov. 11, 2022 published https://en.bitcoin.it/wiki/Protocol_documentation), Ethereum (see e.g. Ethereum documentation of Aug. 15, 2022 published on https://ethereum. org/en/developers/docs/), Solana (see e.g. Solana documentation of Nov. 11, 2022 published on https://spl. solana. com/), Polygon (see e.g. Polygon documentation of Nov. 11, 2022 published on https://wiki. polygon. technology/) or other implementations with varying degree of data transactions performed on the distributed ledger. The description of the example framework is only for illustrative purposes and shall not be considered limiting.

FIG. 8 shows an example of ID-based certificate data, ID-based digital representation of material data or product data and an identity manager. The digital representation may signify an access element for accessing the material data or the product data, respectively.

In contrast to the example of FIG. 7, the example of FIG. 8 is certificate based. ID-based certificate data may include authentication data of the certificate owner and the certificate issuer. For example, a cryptographic signature from the issuer may bind the public key of the data owner to the ID. The ID may be a unique ID (such as UID) as described in relation to the DID of FIG. 7. The certificate may be a X.509 certificate such as X509v3. The ID-based digital representation may be associated with the data source of the data owner. The ID-based digital representation may include an ID, authentication data and endpoints associated with inbound material data or product data. Such endpoints may include any digital representation connecting to or pointing to the data source. The data source may store and provide inbound material data and/or product data.

In this certificate-based example, the ID-based digital representation includes one or more certificate(s) associated with the data owner. The certificates may be associated with an identity manager including e.g. a certificate issuing service and/or a dynamic provisioning service providing dynamic attribute tokens (e.g. OAuth Access Tokens). The information required to verify the certificates are provided via an authentication registry associated with the certificate issuing service and/or a dynamic provisioning service. For instance, in the IDSA Reference Architecture Model, Version 3.0 of April 2019, a connector associated with the data owner, a Certification Authority (CA), a Dynamic Attribute Provisioning Service (DAPS) and a connector associated with the data consumer node are used to verify the identity prior to performing a data exchange (not shown). For this purpose, such connectors include one or more certificate(s) such as X.509 certificate(s). This way the connector possesses a unique identifier embedded in a X.509 certificate that identifies the connector instance.

FIGS. 9A and 9B each show an example method for authentication to access material data via decentral identifier(s) and optionally data related to the material data. In the process of authentication, various communication patterns may be implemented to verify identities.

FIG. 9A illustrates one example communication pattern that may occur between a data providing node and a data consuming node. The data providing node 148 and the data consuming node 150 may be part of a decentral network, such as described in the context of FIG. 1D and FIG. 5. In this case, the data providing node may act as verifying entity and no separate service may be used for authentication.

The data consuming node 150 may request a service from the data providing node 148. The request may include the decentral identifier(s, of the data consuming node 150.

In response to the request, the data providing node 148 may access a registry such as a central or decentral authentication registry to retrieve data related to the authentication mechanism(s) associated with the decentral identifier. For instance, the central authentication registry may provide data related to authentication mechanism via an authentication service issuing access token. Further for instance, the decentral authentication registry may provide data related to authentication mechanism by generating a request token. Data related to authentication mechanism may include a public key of the data consuming service.

Based on the retrieved data related to the authentication mechanism(s), the data providing node 148 may generate an authentication request (corresponding for example to authentication request tokens or dynamic attribute tokens). The authentication request may be generated based on a public key or certificate of the data consuming node 150 and/or the private key or certificate of the data provider node 148. The generated authentication request may be sent to the data consuming node 150.

Based on the received authentication request, the data consuming node 150 may generate authentication data for responding to the authentication request. The generated authentication data may be sent back to the data providing node 148.

Receiving the response including the authentication data from data consuming node 150, the data providing node 148 may then validate the authentication data. In response to the validation, the data providing node 148 may grant or deny the service request of the data consuming node 150. In case access is granted, the data consuming node 150 may provide a decentral identifier(s) associated with the respective inbound material data to be retrieved and a decentral participant identifier associated with the data consuming node 150 and the data providing service may validate the provided decentral identifier(s) and decentral participant identifier and—upon validation—may provide the data associated with the decentral identifier(s), such as the inbound material data associated with the respective inbound material.

Validation may include authorizing access to the inbound material data based on access policy data associated with the inbound material data. The access policy data may define decentral participant identifier(s) permitted to access the inbound material data. The access policy data may define one or more authorization rule(s) associated with the usage of the inbound material data. The access policy data may define one or more action(s) permitted to be performed on the inbound material data by data consuming nodes. This allows to filter decentral data consuming nodes requesting access based on the decentral participant identifier(s) associated with said network nodes and requested actions to be performed on the accessed inbound material data. If the request is not authorized, e.g. if decentral data consuming network node 122 is not authorized to access the inbound material data, the peer-to-peer communication channel will be terminated by data providing node 148 and no inbound material data will be provided.

If the request is authorized, data providing node 148 may initiate contract negotiations with data consuming node 150 prior to providing the inbound material data. Data providing node 148 may provide an electronic contract to data consuming node 150. The electronic contract may include one or more authorization rule(s) associated with the decentral identifier. This allows the data consumer to determine usage conditions associated with the provided inbound material data. Data providing node 148 and data consuming node 150 may be configured to negotiate an electronic contract and to sign the negotiated electronic contract. Use of the electronic contract ensures that the data consuming node 150 and further systems handling the inbound material data are complying to at least one authorization rule associated with the inbound material data. Upon signature of the electronic contract, the inbound material data may be gathered based on the provided decentral identifier(s) and access policy data may be applied to the gathered data. The inbound material data resulting from applying access policy data to the gathered inbound material data may be provided by data providing node 148 to data consuming node 150.

FIG. 9B illustrates another example communication pattern that may occur between a data providing node 148, a data consuming node 150 and an authentication service. The data providing node 148 and the data consuming node 150 may be part of a decentral network, such as described in the context of FIG. 1D and FIG. 5.

First, the data consuming node 150 may request a service or initiates a communication with the data providing node 148. The request may include the decentral identifier, such as a DID or certificate, of the data consuming node 150.

Receiving the request, the data providing node 148 may access a distributed ledger to retrieve one or more authentication mechanism(s) associated with the decentral identifier. Based on the retrieved authentication mechanisms(s), the service provider may generate an authentication request. Receiving the request, the data providing node 148 may generate an authentication request.

Here, the at least one of the retrieved authentication mechanisms may be provided via an authentication service 910. As such, in some embodiments, the generated authentication request may be sent to the authentication service 910 directly. Receiving the authentication request from the data providing node 148, the authentication service 910 may generate the authentication data.

The authentication data generated by the authentication service 910 may be sent to the data consuming node 150.

Data consuming node 150 may then, in turn, may pass on the authentication data to the data providing node 148. Receiving the authentication data, the data providing node 148 may then validate the authentication data. In response to the validation, the data providing node 148 may grant or deny the service request of the data consuming node 150, for example as described in the context of FIG. 9A. In case access is granted, the data consuming node 150 may provide a decentral identifier(s) associated with the respective inbound material data to be retrieved and a decentral participant identifier associated with the data consuming node 150 and the data providing node 148 may validate the provided decentral identifier(s) and—upon validation—may provide the data associated with the decentral identifier(s), such as the material data associated with the respective inbound material, for example as described in the context of FIG. 9A.

Alternatively, in some embodiments, after the data providing node 148 may generate an authentication request, the data providing node 148 may send the authentication requests to data consuming node 150. The data consuming node 150 may pass on the authentication request to the authentication service 910.

Further, after the authentication service 910 may generate the authentication data, in some embodiments, the authentication service merely contacts the data consumer node 150 to notify the receipt of the authentication request and to obtain consent. When the data consumer node 150 receives the notification, the data consumer node 150 may consent and send the consent back to the authentication service 910. Receiving the consent, the authentication service may then send the authentication data directly to the data providing node 148.

Finally, in many transactions, the authentication may be mutually performed by both nodes. In such a mutual authentication situation, each involved node is both a subject entity and a verifying entity. Data consuming node 150 and data providing node 148 may have control over their decentral identities. At the beginning, services may exchange their decentral identities. Next, each of the services may access a distributed ledger or the authentication service to obtain each other's authentication mechanism(s). Each service may then generate its own authentication request based on the other ID's authentication method(s). The generated authentication data may then be sent to the other node. Receiving each other's authentication data, each node may validate the received authentication data. Based on the validation results, the nodes may then perform additional communications, e.g. one node may grant or deny the service request of the other node.

FIGS. 9A and 9B only show examples of authentication protocols. Also, although the communication arrows were discussed in a certain order or illustrated in a sequence of communications, no particular order is required unless specifically state, or required because a communication is dependent on another communication being completed prior to the communication being transmitted.

FIG. 10A to 10C show different example configurations for digital representations of inbound material data and/or product data anchored by decentral identifiers. The configurations include different parent, child, grandchild and so on relationships for such digital representations generated in the chemical value chain up to an end product.

FIG. 10A illustrates an individual configuration for different digital representations generated in the chemical value chain. Individual digital representations may be generated for multiple stages in the chemical value chain. The generation of the digital representation may include the providing of a decentral identifier and an authentication mechanism for each of the multiple stages. The digital representations for the multiple stages may be based on crypto signatures. For instance, the digital representations for the multiple stages may be concatenated through hash values based on different digital representations. As shown in FIG. 10A hash 1 may be based on data of the inbound material digital representation, hash 2 may be based on data of chemical product digital representation and hash 3 may be based on data of the inbound material digital representation plus data of the chemical product digital representation. The hash value hash may be generated via a hashing algorithm such as MD5, SHA-1, SHA-2, SHA-3 or any other suitable algorithm based on a one-way function that can't be reverse engineered. The hash value hash may be generated based on data included in or connected to the respective digital representation. The hash value hash 1 may be used by participant nodes of the chemical supply chain to check integrity of the data package transferred from the raw material supplier e.g. to the chemical product producer.

The concatenation associated with multiple decentral identifiers may relate to the decentral identifiers associated with the chemical product and the raw material(s). For instance, the chemical product digital representation associated with the chemical product may contain hash 2 and hash 3. Hashing data related or included in the respective digital representations may provide for such concatenation. The combined hash value(s) may further be used by participant nodes of the chemical supply chain to determine the relation of products at different stages and to check integrity of such relation. Concatenation via hashes of the crypto signature is only one example concatenation. Other examples include permission aggregations with different scope of data that may be embedded in child digital representations, public key aggregations with different crypto signatures or service endpoint aggregation with different links.

FIG. 10B illustrates an anchored configuration for different digital representations generated in the chemical value chain. For the end product an end product digital representation is generated. For multiple further stages in the chemical value chain individual digital representations may be generated and embedded in or linked with the end product digital representation. The digital representation generation may include the providing of a decentral identifier and an authentication mechanism for each of the multiple stages. The digital representations for the multiple product stages may be based on crypto signatures. For instance, the digital representations for the multiple further stages may be concatenated through hash values based on different digital representations. As shown in FIG. 9B hash 1 may be based on data of the inbound material digital representation, hash 2 may be based on data of the chemical product digital representation and hash 3 may be based on data of the inbound material digital representation plus data of the chemical product digital representation. Further concatenation may be done for other combinations of digital representations up to hash n, which concatenates digital representations up to the end product digital representation. Concatenation via hashes of the crypto signature is only one example concatenation. Other examples include permission aggregations with different scope of data that may be embedded in child digital representations, public key aggregations with different crypto signatures or service endpoint aggregation with different links. FIG. 10C illustrates a fully embedded configuration for different digital representations generated in the chemical value chain. Individual digital representations may be generated for multiple stages in the chemical value chain. The digital representation generation may include the providing of a decentral identifier and an authentication mechanism for each of the multiple stages. The digital representations for the multiple stages may be based on crypto signatures. For instance, the digital representations for the multiple stages may be concatenated through hash values based on different digital representations. As shown in FIG. 10C hash 1 may be based on data of the inbound material digital representations. Hash 2 may be based on data of the inbound material digital representations and the chemical product digital representations. Further concatenation may be done for other combinations of digital representations up to hash n, which concatenates digital representations up to the end product digital representation. Concatenation via hashes of the crypto signature is only one example concatenation. Other examples include permission aggregations with different scope of data that may be embedded in child digital representations, public key aggregations with different crypto signatures or service endpoint aggregation with different links.

FIG. 11 illustrates a flow chart of an example of a computer-implemented method for generating preference data associated with a product. The product may be produced by a production, such as a production described in FIGS. 2 to 3C, from at least one inbound material. The product may be a chemical product, such as described in FIGS. 3A, 3B and 3D. The product may be a discrete product, such as described in FIGS. 3C and 3D. The production may be associated with an operating system, such as operating system 208 described in relation to FIGS. 2 and 5. The method illustrated in FIG. 11 may be implemented by the operating system 208. The preference data may include a preferential origin status or the non-preferential origin status for at least one country or at least one region. The preference data may further include product data contained in the received request, such as the product identifier, price data, customs tariff classification and/or product composition data. The preference data may further include data associated with the inbound material(s) used in the production of the product, such as a description of the respective inbound material(s), the customs tariff classification of the respective inbound material(s) and/or the value, e.g. price, of the respective inbound material(s).

In block 1102, a request to generate preference data associated with the produced product may be received. The request may be received by operating system 208. The request may be triggered as described in relation to FIG. 5. The received request may contain product data. The product data may include the product identifier, product composition data, price data, a product customs tariff classification, or a combination thereof. For instance, the received request may contain the product identifier associated with the produced product the preference data is to be generated for. The product data may contain data related to one or more countries or regions the preferential data is to be generated for. For instance, the product data may include an indication for which country/countries or for which region(s) the product needs to satisfy respective rule(s) of origin governing preferential trade with said country/countries or region(s).

In block 1104, the operating system 208 may retrieve-based on the received product data preference data associated with the inbound material(s) used to produce the product. The operating system may determine-based on the received product data-inbound material identifier(s) associated with inbound material(s) used to produce the product. For instance, the operating system may be configured to retrieve the product composition data based on the received product data and to determine material identifier(s) using the determined product composition data. In another instance, the operating system may be configured to determine inbound material identifier(s) based on the product composition data contained in the received request.

The preference data may be retrieved from inbound material data associated with said inbound materials. The inbound material data may be accessed-based on a decentral identifier and optionally based on data related to the respective inbound material data-by a data consuming node via a decentral network as described in relation to FIG. 5. The access to the inbound material data may be under control of a data providing node associated with a data owner, such as the data owner of the inbound material data as described in relation to FIGS. 5, 6, 9A and 9B. The preference data may be retrieved from the accessed inbound material data using the respective decentral identifier or inbound material identifier determined as previously described. The preference data associated with the respective inbound material may include data on the preferential origin status or the non-preferential origin status of said inbound material for at least one country, and an inbound material price. Apart from the preference, data, the inbound material data may contain the data previously mentioned in relation to FIG. 4A.

In block 1106, rule(s) of origin for attributing a country of origin to a product produced from at least one inbound material may be retrieved by the operating system 208. The rule(s) may be stored on a data storage medium, for example as described in relation to FIGS. 4A, 4B and 5. The rules may be retrieved based on the product data received in block 1002. For instance, the rule(s) of origin may be retrieved based on country data contained in the product data. In another instance, the rule(s) of origin may be retrieved based on the customs tariff classification contained in the product data. The retrieved rule(s) may include at least one rule related to wholly obtained products and/or at least one rule related to the substantial transformation of a material used to produce the product as previously described. In block 1108, the operating system 208 may generate preference data associated with the produced product based on the rule(s) of origin retrieved in block 1106, the preference data retrieved in block 1104 and product data received in block 1102. The preference data may be generated by determining the origin of the produced produce based on the rule(s) retrieved in block 1106, the preference data retrieved in block 1104 and the product data received in block 1102. The determined origin may then be used to determine the preference status based on the determined origin. In block 1108, the operating system may be configured to retrieve price data associated with the product and/or a customs tariff classification associated with the product if said data is not already contained in the received product data.

In block 1110, the preference data generated in block 1108 may be provided by the operating system 208, for example via a communication interface. For instance, the generated preference data may be provided to a display device for display. The generated preference data may be provided to a data storage medium for storage. Providing said generated preference data to a data storage medium may include interrelating said data with a product identifier. The generated preference data may be used to generate a product passport as described in relation to FIG. 4A.

Use of inbound material data containing preference data associated with the respective inbound material allows to determine the preference data of product(s) produced from said inbound material from the preference data contained in the accessed inbound material data without having to perform any time-consuming and error prone data integration of the preference data associated with the provided inbound material(s). Moreover, the inbound material data accessed via a data consuming node from a decentral network allow for simplified and customizable data sharing or exchange from chemical industry to further supply chain participants. This way, a more reliable and efficient determination of preference data associated with product(s) produced from supplied materials by upstream participants of the supply chain can be achieved, while the inbound material data remains in the ownership of the supplier supplying the upstream participant. By combining the data related to inbound material data directly with the decentral identifier and optionally one or more authentication mechanisms more reliable and secure data sharing and exchange can be provided. Further use of one or more authorization mechanisms allows to conduct the data sharing or exchange in a more flexible manner with multiple data consuming services from different participants of the supply chain accessing the inbound material data.

By generating preference data for produced product(s) and attaching said generated preference data as a digital asset to such produced product(s), production of further product(s) using said produced product(s) as inbound material may be steered or controlled based on the associated preference data (e.g. the associated digital asset including the preference data). For instance, the flow of produced products delivered by the product producer to a downstream participant of the product ecosystem may be controlled or steered by the downstream participant based on associated preference data such that further products produced from such received product flow may fulfil target preference data.

FIG. 12 illustrates a flow chart of an example of a computer-implemented method for generating preference data associated with a product. In contrast to FIG. 11, the product is produced by a production, such as a production described in FIGS. 2 to 3C, from at least one inbound material and/or a least one intermediate product. The product may be a product described in relation to FIG. 11. The method of FIG. 12 may be implemented by an operating system as described in the context of FIG. 11. The intermediate product(s) may include intermediate product(s) produced from inbound material(s) (denoted as first intermediate product(s) hereinafter). The intermediate product(s) may include intermediate product(s) produced from first intermediate product(s) and optionally one or more inbound material(s) (denoted as second intermediate product(s) hereinafter). The production may be associated with an operating system, such as operating system 208 described in relation to FIGS. 2 and 5. The preference data may include the data described in relation to FIG. 11.

In block 1202, a request to generate preference data associated with the produced product may be received as described in relation to FIG. 11. The request may contain product data as described in relation to FIG. 11.

In block 1204, preference data associated with the inbound material(s) used to produce the product may be retrieved from inbound material data associated with said inbound material(s) as described in relation to FIG. 11.

In block 1206, the operating system 208 may determine whether a chain of intermediate products is used in the production of the product. A chain of intermediate products may denote the use of 2 different intermediate products in the production of the product, wherein at least one intermediate product (e.g. second intermediate product) is produced at least partially from an intermediate product previously produced by the production (e.g. first intermediate product). The determination may be made based on the product data contained in the received request. For instance, the product composition data may be used to retrieve intermediate product composition data associated with the respective intermediate products used to produce the product. From said intermediate product composition data, the operating system 208 may determine whether a chain of intermediate products is used or not. In accordance with the determination, that a chain of intermediate products is used, the operating system may proceed to block 1210, otherwise, it may proceed to block 1208.

In block 1208, the operating system may generate preference data associated with intermediate product(s) used in the production (e.g. with first intermediate products). The operating system may retrieve intermediate product data based on the received product data. The intermediate product data may include an intermediate product identifier, price data, intermediate product composition data and/or a customs tariff classification associated with the intermediate product. The intermediate product composition data may be used to determine inbound material identifiers associated with the used inbound materials(s). The inbound material identifier(s) may be used to retrieve the preference data as described in relation to FIG. 11.

The operating system 208 may retrieve at least one rule of origin for attributing a country of origin to the intermediate product(s). The rule of origin may be retrieved as described in relation to FIG. 11 using the retrieved intermediate product data.

The operating system may generate preference data associated with the first intermediate product(s) based on the retrieved rule(s) of origin, the preference data retrieved in block 1204, and the retrieved intermediate product data. The preference data may be generated as described in relation to FIG. 11. The generated preference data may be stored on a data storage medium.

In block 1110, the operating system 208 may generate preference data associated with the first intermediate products as described in relation to block 1108.

In block 1112, the operating system 208 may generate preference data associated with the second intermediate product(s) produced at least partially from the first intermediate products. The operating system 208 may retrieve second intermediate product data based on the received product data. The second intermediate product data may be used to determine the first intermediate product(s) and optionally the inbound material(s) used to produce the second intermediate product(s). For instance, the second intermediate product data may include the second intermediate product composition containing respective identifiers. The identifiers may be used to retrieve preference data previously generated for the first intermediate products (see for instance block 1208) and preference data associated with inbound materials as described in relation to block 1204. The operating system 208 may retrieve rules of origin as described in relation to block 1208.

The preference data for the second intermediate product(s) may be generated as described in relation to FIG. 11 based on the retrieved preference data associated with the first intermediate product, optionally the retrieved preference data associated with the inbound material(s), the retrieved rule(s) or origin, and the retrieved second intermediate product data.

In block 1214, rules of origin for attributing a country of origin to the product may be retrieved as described in relation to FIG. 10.

In block 1216, preference data associated with the product based on the rule(s) of origin retrieved in block 1216, the preference data retrieved in block 1204 and/or generated in blocks 1210 and 1212 or generated in block 1208, and product data received in block 1202 may be generated by operating system 208 as described in relation to FIG. 11.

In block 1218, the generated preference data may be provided as described in relation to FIG. 11.

FIG. 13 illustrates a flow chart of an example of a method for producing a product associated with preference data. The product may be a product described in relation to FIG. 11. The product may be a product described in relation to FIG. 11. The preference data may include the data previously mentioned in relation to FIG. 11. The method illustrated in FIG. 13 may be implemented by an operating system, for example as described in the context of FIG. 11.

In block 1302, one or more inbound material(s) may be provided to the production. The production may produce a product at least in part from the inbound material(s) provided to the production. The production may be a production as described in FIGS. 2 to 3C. The production may be associated with an operating system, such as operating system 208 described in relation to FIGS. 2 and 5.

In block 1304, a request to generate preference data associated with the produced product may be received as described in relation to FIG. 11. The request may contain product data as described in relation to FIG. 11.

In block 1306, preference data associated with the inbound material(s) used to produce the product may be retrieved from inbound material data associated with said inbound material(s) as described in relation to FIG. 11.

In block 1308, rules of origin for attributing a country of origin to the produced product may be retrieved by operating system 208 as described in relation to FIG. 11.

In block 1310, preference data associated with the produced product based on the rule(s) of origin retrieved in block 1308, the preference data retrieved in block 1306, and product data received in block 1304 may be generated by operating system 208 as described in relation to FIG. 11.

In block 1312, the preference data generated in block 1310 may be associated by the operating system 208 with the produced product. Associating the generated preference data with the produced product may include linking the generated preference data to an identifier associated with the produced product. For instance, a product identifier associated with the produced product may be linked with the generated preference data. The product identifier may be contained in the product data received in block 1304. This may allow to retrieve the preference data using the respective product identifier. The product identifier may include a decentral identifier. For instance, a product passport may be generated including the decentral identifier associated with product data including the generated preference data and product data as previously described in relation to FIG. 4A. A digital access element may be generated including the decentral identifier(s) and access data. The digital access element may be used to access the preference data associated with the product, for example via a data consuming node associated with the product consumer (see to FIG. 6).

FIGS. 14A and 14B illustrate a flow chart of an example of a method for producing a product associated with preference data. The product may be a product described in relation to FIG. 11. In contrast to FIG. 13, the product may be produced by a production, such as a production described in FIGS. 2 to 3C, from at least one inbound material and/or a least one intermediate product. The intermediate product(s) may include intermediate product(s) produced from inbound material(s) (denoted as first intermediate product(s) hereinafter). The intermediate product(s) may include intermediate product(s) produced from first intermediate product(s) and optionally one or more inbound material(s) (denoted as second intermediate product(s) hereinafter). The preference data may include the data previously mentioned in relation to FIG. 11. The methods illustrated in FIG. 14A and FIG. 14B may be implemented by an operating system, for example as described in the context of FIG. 11.

In block 1402, one or more inbound material(s) may be provided to the production. The production may produce a product at least in part from the inbound material(s) provided to the production. The production may produce intermediate product(s) from the provided inbound material(s). The production may produce the product at least in part from the produced intermediate product(s). The production may be a production as described in FIGS. 2 to 3C. The production may be associated with an operating system, such as operating system 208 described in relation to FIGS. 2 and 5.

In block 1404, a request to generate preference data associated with the produced product may be received as described in relation to FIG. 11. The request may contain product data as described in relation to FIG. 11.

In block 1406, preference data associated with the inbound material(s) used to produce the product may be retrieved from inbound material data associated with said inbound material(s) as described in relation to FIG. 11.

In block 1408, the operating system 208 may determine whether a chain of intermediate products is used in the production of the product as described in relation to FIG. 12. In accordance with the determination that a chain of intermediate products is used, the operating system may proceed to block 1410, otherwise, it may proceed to block 1414.

In block 1410, the operating system 208 may generate preference data associated with the first intermediate products as described in relation FIG. 12.

In block 1412, the operating system 208 may generate preference data associated with the second intermediate product(s) produced at least partially from the first intermediate product(s) as described in relation to FIG. 12.

In block 1414, the operating system may generate preference data associated with intermediate product(s) used in the production (e.g. with first intermediate product(s)) as described in relation to FIG. 12.

In block 1416, rules of origin for attributing a country of origin to the produced product may be retrieved as described in relation to FIG. 11.

In block 1418, preference data associated with the product based on the rule(s) of origin retrieved in block 1416, the preference data retrieved in block 1406 and/or generated in blocks 1410 and 1412 or generated in block 1414, and product data received in block 1404 may be generated by operating system 208 as described in relation to FIG. 11.

In block 1420, the preference data generated in block 1418 may be associated by the operating system 208 with the produced product as described in relation to FIG. 12.

FIG. 15 illustrates an example of a system for producing a product associated with preference data including an example method for generating preference data associated with the product produced from inbound material(s).

The inbound materials may be chemical materials, such as polymers, pigments, solvents and further components necessary to prepare a coating material. The inbound materials may be discrete materials (see for example FIG. 3D), The inbound materials may be chemical materials and discrete materials (see for example FIG. 3D). The inbound materials may be provided to the chemical production 204. The chemical production may be a chemical production as described in relation to FIGS. 2 to 3C. The inbound materials may enter the system boundary of the chemical production 204 at the entry point, such as a resin plant, pigment paste plant, coating material production or a material storage. The inbound materials may be used in the chemical production 204 to produce one or more products from the inbound materials. The product(s) may be provided on exit points of the chemical production 204. The product(s) may be chemical product(s). Chemical products may be pigment pastes, base varnishes, thinners, rheology modifying agents and coating materials.

On the virtual layer, inbound material data associated with the received inbound material(s) may be accessed 1508. The inbound material data may be accessed using decentral identifier(s) and optionally data related to the inbound material data via a data consuming node, for example as described in relation to FIG. 5 and FIG. 6. The inbound material data may be accessed on, prior or after providing of the one or more inbound material(s) at entry points to the chemical production 204.

The decentral identifier(s) may be associated with the physical entity of the inbound material entering the chemical production 204 as previously described.

The inbound material data may include preference data associated with the respective inbound material, such as the origin of the inbound material, preferential status, data on non-originating compounds used to produce the inbound material or a combination thereof. The inbound material data may further include the property data, emission data, recyclate content, bio-based content and/or production data described previously. The inbound material data may be interrelated with the decentral identifier(s) and may be stored on a data storage medium, such as a dedicated storage connected to a data consuming node associated with the data owner of the inbound material data (see FIG. 5). This allows to retrieve the stored inbound material data using the decentral identifier(s) via the decentral network under control of the data owner of the inbound material data. The inbound material data may be transferred from a computing system to the operating system 208 or may be retrieved by operating system 208 using the decentral identifier(s).

The inbound materials fed to the chemical production 204 may be used to produce one or more chemical product(s) 1502. For example, inbound materials may be raw materials used to produce a coating material and the chemical production 204 produces coating materials as described in relation to FIGS. 3A and 3B. The inbound material(s) required to produce the chemical product(s) may be provided based on material demand data as described in relation to FIGS. 3A and 3B. The material demand data may specify the production chain(s) of the chemical production 204. The material demand data may include a bill of materials for one or more production chain(s) of the chemical production 204. The material demand data may include one or more recipe(s) specifying one or more material(s) for production process(es) of the chemical production.

On the virtual layer, the operating system 208 may receive a request to generate preference data associated with the produced product 1510. The request may be triggered as described in relation to FIG. 4A. The request may contain product data associated with the product for which preference data is to be generated (see for example FIGS. 11 to 14B). The product data may include a product identifier. The product identifier may be associated with the physical entity of the respective product produced by chemical production 204. This way, the virtual identifier of a product may be uniquely linked to the physical product. Such linking may include a physical or virtual link of identifiers uniquely associated with the physical product. The request may further include data related to one or more countries the preference data is to be generated for. Said data may be used by operating system 208 to determine the appropriate FTA(s) and to retrieve interrelated rules of origin as previously mentioned. The request may further include price data, such as ex-works price data, and/or a customs tariff classification associated with the product.

In response to the request, the operating system 208 may retrieve the preference data contained in the accessed or stored inbound material data based on the received product data 1512, for example as described in relation to FIGS. 4A, 5 and 11 to 14B.

The operating system 208 may retrieve rule(s) of origin 1514. The rule(s) of origin may be retrieved prior to or after receiving the product data. Retrieving the rule(s) of origin after receiving the product data may allow to retrieve less amounts of data because the appropriate rule(s) of origin can be retrieved based on the received product data, thus avoiding retrieval of inapplicable rule(s) of origin. The rules of origin may be retrieved by operating system 208 from a data storage, such as a database, which contains rule(s) of origin interrelated with a data related to the respective free trade agreement. The database may be a database associated with chemical production 204 or it may be a data storage, such as a cloud database, provided by a third party. The use of a cloud database may avoid the need to update the rule(s) of origin on a frequent basis to ensure generation of correct preference data. Data related to the free trade agreement may include an identifier, such as a name, a number, etc. and/or data on the contracting parties associated with the FTA. Data on the contracting parties may be used to retrieve the appropriate rule(s) of origin, for example if the product data received by operating system 208 contains data related to a country the preference data is to be generated for. In this case, operating system 208 uses the data on the country to determine the applicable free trade agreement(s) and retrieves the rule(s) of origin interrelated with said determined countries.

The operating system 208 may generate preference data 1516 based on the retrieved preference data, the received rule(s) of origin and received product data, for example as described in relation to FIGS. 5 and 11 to 14B. The operating system 208 may associate the generated preference data with the product data, such as the product identifier. The operating system 208 may store the generated preference data on a data storage medium 1518. The stored preference data may be interrelated with the product data, such as the product identifier to facilitate retrieval of said data.

The product associated with the product identifier may be provided physically to a downstream participant of the product ecosystem, such as a customer of the entity producing the product, and the preference data associated with said product identifier may be provided virtually, e.g. in the form of a digital asset. Through the association of the physical product and preference data with the product identifier the physical entity of the product is connected to the virtual entity of the preference, such as the preferential origin or the non-preferential origin of the product. Virtual provision of the preference data may include interrelating said data with a decentral identifier to generate a product data set which is provided by a data providing node associated with the data owner of the preference data to a data consuming node associated with the downstream participant as described previously.

The described system allows to generate preference data of products produced by a chemical production network using material data associated with inbound materials without having to integrate the material data into existing systems used to determine the preference data. Instead, the use of material data sets allows to use the contained material data as is, without having to perform time consuming and error-prone data integration of material data provided by suppliers of the supplied inbound materials.

By attaching the generated preference data as a digital asset to produced product(s), production of further product(s) using said produced product(s) as inbound material may be steered or controlled by the downstream participant based on the associated preference data (e.g. the associated digital asset including the preference data). For instance, the flow of produced products delivered by the product producer to a downstream participant of the product ecosystem may be controlled or steered by the downstream participant based on associated preference data such that further products produced from such received product flow may fulfil target preference data.

FIG. 16 illustrates an example of a system for producing a product associated with preference data including an example method for generating preference data associated with the product produced from inbound material(s) and/or intermediate product(s). The intermediate product(s) may be produced from one or more inbound material(s)

The inbound materials may be chemical materials as described in FIG. 15. The inbound materials may be discrete materials as described in FIG. 15. The inbound materials may be chemical materials and discrete materials as described in FIG. 15. The inbound materials may be provided to the chemical production 204. The chemical production may be a chemical production as described in relation to FIGS. 2 to 3C. The inbound materials may enter the system boundary of the chemical production 204 at the entry point, such as a resin plant, pigment paste plant, coating material production or a material storage. The inbound materials may be used in the chemical production 204 to produce one or more intermediate product(s) and product(s) from the inbound materials. The one or more intermediate product(s) may be used to produce the one or more product(s). The product(s) may be provided on exit points of the chemical production 204. The product(s) may be chemical product(s). Chemical products may be pigment pastes, base varnishes, thinners, rheology modifying agents and coating materials.

On the virtual layer, inbound material data associated with the received inbound material(s) may be accessed 1610 as described in FIG. 15. The inbound material data may include preference data associated with the respective inbound material, such as the origin of the inbound material, preferential status, data on non-originating compounds used to produce the inbound material or a combination thereof. The inbound material data may further include the data mentioned in relation to FIG. 15. The inbound material data may be transferred from a computing system to the operating system 208 or may be retrieved by operating system 208 using the material identifier.

The inbound materials fed to the chemical production 204 may be used to produce one or more chemical product(s) 1602. For example, inbound materials may be raw materials used to produce a coating material and the chemical production 204 produces coating materials as described in relation to FIGS. 3A and 3B. The inbound material(s) required to produce the chemical product(s) may be provided based on material demand data as described in relation to FIGS. 3A and 3B. The material demand data may specify the production chain(s) of the chemical production 204. The material demand data may include a bill of materials for one or more production chain(s) of the chemical production 204. The material demand data may include one or more recipe(s) specifying one or more material(s) for production process(es) of the chemical production. The inbound material(s) required to produce the intermediate product(s) may be provided based on material demand data as described previously. The intermediate product(s)

On the virtual layer, the operating system 208 may receive a request to generate preference data associated with the produced product 1610 as described in relation to FIG. 15. The request may be triggered as described in relation to FIG. 4A. The request contains product data associated with the product for which preference data is to be generated (see for example FIGS. 11 to 14B). The product data may include a product identifier as described in relation to FIG. 15. The request may further include data related to one or more countries the preference data is to be generated for. Said data may be used by operating system 208 to determine the appropriate FTA(s) and to retrieve interrelated rules of origin as previously mentioned. The request may further include price data, such as ex-works price data, and/or a customs tariff classification associated with the product.

In response to the request, the operating system 208 may retrieve the preference data contained in the accessed or stored inbound material data based on the received product data 1614, for example as described in relation to FIGS. 4A, 5 and 11 to 14B.

The operating system 208 may generate preference data associated with the intermediate product(s) 1616. The preference data associated with intermediate product(s) may be generated as described in relation to FIGS. 12, 14A and 14B.

The operating system 208 may retrieve rule(s) of origin 1618 as described in relation to FIG. 15. The rule(s) of origin may be retrieved prior to or after receiving the product data. Retrieving the rule(s) of origin after receiving the product data may allow to retrieve less amounts of data because the appropriate rule(s) of origin can be retrieved based on the received product data, thus avoiding retrieval of inapplicable rule(s) of origin.

The operating system 208 may generate preference data 1620 based on the retrieved preference data 1614 and/or the generated preference data 1618, the received rule(s) of origin and received product data, for example as described in relation to FIGS. 5 and 11 to 14B. The operating system 208 may associate the generated preference data with the product data, such as the product identifier. The operating system 208 may store the generated preference data on a data storage medium. The stored preference data may be interrelated with the product data, such as the product identifier to facilitate retrieval of said data.

The operating system 208 may associate the generated preference data with the produced product 1622, for example as described in relation to FIGS. 12, 14A and 14B. The product associated with the product identifier may be provided physically to a downstream participant, such as a customer of the entity producing the product, and the preference data associated with said product identifier may be provided virtually. Through the association of the physical product and preference data with the product identifier the physical entity of the product is connected to the virtual entity of the preference, such as the preferential origin or the non-preferential origin of the product. Virtual provision of the preference data may include interrelating said data with a decentral identifier to generate a product data set which is provided by a data providing node associated with the data owner of the preference data to a data consuming node associated with the downstream participant as described previously.

The described system allows to generate preference data of products produced by a chemical production network using material data associated with inbound materials without having to integrate the material data into existing systems used to determine the preference data. Instead, the use of material data sets allows to use the contained material data as is, without having to perform time consuming and error-prone data integration of material data provided by suppliers of the supplied inbound materials.

By attaching said generated preference data as a digital asset to such produced product(s), production of further product(s) using said produced product(s) as inbound material may be steered or controlled by the downstream participant based on the associated preference data (e.g. the associated digital asset including the preference data). For instance, the flow of produced products delivered by the product producer to a downstream participant of the product ecosystem may be controlled or steered by the downstream participant based on associated preference data such that further products produced from such received product flow may fulfil target preference data.

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at different nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

1. A computer-implemented method for generating preference data associated with a product, wherein the product is produced by a production from at least one inbound material, the method including:
(a) receiving a request to generate the preference data, said request including product data associated with the product,
(b) retrieving-based on the received product data-preference data associated with the inbound material(s) from inbound material data associated with said inbound material(s), wherein the inbound material data associated with each inbound material is accessed-based on a decentral identifier associated with the respective inbound material data, and optionally based on data related to the respective inbound material data-by a data consuming service under control of a data providing service being associated with a data owner, said data owner being associated with the respective inbound material data;
(c) retrieving at least one rule of origin for attributing a country of origin to the product produced from the at least one material;
(d) generating preference data associated with the product based on the retrieved rule(s) of origin, the retrieved preference data, and the received product data; and
(e) providing, via a communication interface, the generated preference data.

2. The computer-implemented method of claim 1, wherein the preference data associated with the product includes at least the preferential origin status or the non-preferential origin status of the product for at least one country or at least one region.

3. The computer-implemented method of claim 1, wherein the product data includes a product identifier, price data, product composition data and/or a customs tariff classification associated with the product.

4. The computer-implemented method of claim 1, wherein the decentral identifier is associated with the data owner and/or with the inbound material the inbound material data is associated with.

5. The computer-implemented method of claim 1, wherein the preference data is retrieved using the decentral identifier and/or inbound material identifier(s) associated with the inbound material(s).

6. The computer-implemented method of claim 1, wherein the preference data associated with the respective inbound material includes data on the preferential origin status or the non-preferential origin status of said material for at least one country, and a material price.

7. The computer-implemented method of claim 1, wherein the data related to the inbound material data includes one or more digital representation(s) pointing to the inbound material data or parts thereof.

8. The computer-implemented method of claim 1, wherein the at least one rule of origin is retrieved based on the received product data.

9. The computer-implemented method of claim 1, wherein the at least one rule of origin includes at least one rule related to wholly obtained products and/or at least one rule related to the substantial transformation of a material used to produce the product and/or the substantial transformation of an ingredient used to produce the material.

10. The computer-implemented method of claim 1, wherein generating preference data includes:
determining the origin based on the received rule(s) of origin and the received preference data, and
determining the preference status based on the determined origin.

11. An apparatus for generating preference data associated with a product produced from at least one material, the apparatus comprising:
one or more computing nodes; and one or more computer-readable media having thereon computer-executable instructions that are structured such that, when executed by the one or more computing nodes, cause the apparatus to perform the method as claimed in claim 1.

12. A computer element with instructions, which when executed on one or more computing node(s) are configured to carry out the steps of the method as claimed in claim 1.

13. A method for producing at least one product associated with preference data, wherein the product is produced by a production from at least one inbound material, the method including:
(a) providing the inbound material(s) to a production and producing the at least one product from at least part of the provided inbound material(s) using the production,
(b) receiving a request to generate the preference data, said request including product data associated with the product,
(c) retrieving-based on the received product data-preference data associated with at least part of the inbound material(s) from inbound material data associated with said part of the inbound materials, wherein the inbound material data associated with each inbound material of said part of inbound materials is accessed-based on a decentral identifier associated with the inbound material data, and optionally based on data related to the inbound material data-by a data consuming service under control of a data providing service being associated with a data owner, said data owner being associated with the respective inbound material data,
(d) retrieving at least one rule of origin for attributing a country of origin to the produced product, and
(e) generating preference data based on the received product data, the retrieved preference data and the received rule(s) of origin, and associating said generated preference data with the produced product.

14. A system configured to produce a product associated with preference data from one or more inbound material(s) and to provide the produced product associated with the preference data, the system including:
(a) a production line configured to produce the product from the inbound material(s) and to provide the produced product, wherein the product is connected to or comprises a physical identifier,
(b) a collector configured to collect product data associated with the product,
(c) a request receiver configured to receive a request to generate the preference data, said request including product data associated with the product,
(d) a preference data provider configured to retrieve—based on the received product data—preference data associated with at least part of the inbound material(s) from inbound material data associated with said part of the inbound materials, wherein the inbound material data associated with each inbound material of said part of inbound materials is accessed—based on a decentral identifier associated with the inbound material data, and optionally based on data related to the inbound material data—by a data consuming service under control of a data providing service being associated with a data owner, said data owner being associated with the respective inbound material data,
(e) a rule provider configured to retrieve at least one rule of origin for attributing a country of origin to a product produced from at least one inbound material;
(f) a preference data generator configured to generate preference data associated with the produced product based on the received product data, the retrieved preference data and the retrieved rule(s) rule of origin, and
(g) an assignor configured to assign the physical identifier to the generated preference data.

15. A computer element with instructions, which when executed on one or more computing node(s) are configured to be carried out by the apparatus as claimed in claim 11.
